(19) United States
(12) Patent Application Publication
(10) Pub. No.: US 2026/0202632 A1
(43) Pub. Date: Jul. 16, 2026

(54) OPTICAL MODULE

(71) Applicant: HISENSE BROADBAND MULTIMEDIA TECHNOLOGIES CO., LTD., Shandong (CN)

(72) Inventors: Ying YE, Qingdao (CN); Honghao ZHANG, Qingdao, (CN); Yizhou XU, Qingdao (CN)

(21) Appl. No.: 19/566,539

(22) Filed: Mar. 13, 2026

Related U.S. Application Data
(63) Continuation of application No. PCT/CN2023/131513, filed on Nov. 14, 2023.

(30) Foreign Application Priority Data
Sep. 15, 2023 (CN) 202311194032.5
Sep. 15, 2023 (CN) 202311197656.2
Sep. 15, 2023 (CN) 202311197854.9

(51) Int. Cl. G02B 6/42; H04B 10/40

(52) U.S. Cl. CPC G02B 6/4246; H04B 10/40

(57) ABSTRACT

An optical module including a circuit board and an optical transceiver part having a transceiver body that is provided with a first notch, one end of the circuit board is inserted in the first notch. An upper surface of the transceiver body has a first and second receiving grooves, a lower surface of the transceiver body has a first emission groove, a emission launch groove and a third emission groove that are sequentially arranged in height. An optical receiver is arranged in the receiving grooves to realize reception of optical signals; and an optical emitter is arranged in the emission grooves so as to realize emission of optical signals.

This application is a continuation of international application PCT/CN2023/131513 filed on Nov. 14, 2023, which claims priority to application No. 202311194032.5 filed with the Chinese Patent Office on Sep. 15, 2023, and to application No. 202311197854.9, and to application No. 202311197656.2 filed with the Chinese Patent Office on Sep. 15, 2023. All of the above-mentioned applications are incorporated by reference into the present disclosure.

### FIELD OF THE INVENTION

The present disclosure relates to the field of optical fiber communication, in particular to an optical module.

### BACKGROUND OF THE INVENTION

With the development of new services and application models such as cloud computing, mobile Internet, and video, the development and progress of optical communication technology has become more and more important. In optical communication technology, optical modules are tools to realize the mutual conversion of photoelectric signals, and are one of the key devices in optical communication equipment, and with the development of optical communication technology, the transmission rate of optical modules continues to increase.

### SUMMARY OF THE INVENTION

Some embodiments of the present disclosure provide an optical module, comprising:
circuit board, the circuit board is provided with an electrical chip and an optical receiving chip group; The electrical chip is connected with the optical receiving chip group, and the two adjacent first electrical connection points of the electric chip are equally spaced;
the optical transceiver part comprises a transceiver body, the transceiver body is provided with a first notch at one end facing the circuit board, and the circuit board is clamped at the first notch;
the upper surface of the transceiver body is provided with a receiving groove, the receiving groove comprises a first receiving groove and a second receiving groove, a receiving substrate and an optical receiver are arranged in the first receiving groove, the second receiving groove is configured to place an optical fiber, and the height of the first receiving groove is lower than the height of the second receiving groove;

The optical receiver comprises an optical fiber collimator group, a demultiplexer group, an optical path offset sheet group and a transition prism, the optical fiber collimator group is connected with the optical fiber, wherein the optical fiber collimator group, the demultiplexer group and the optical path offset sheet group are arranged on the receiving substrate, and the optical path offset sheet group is located between the splitter group and the transition prism; The turning prism is located above the light receiving chip group; the optical receiving chip group comprises a plurality of optical receiving chips arranged in parallel, the first pads of the plurality of optical receiving chips are arranged at equal intervals, the demultiplexer group comprises at least two demultiplexers, the demultiplexer has a plurality of optical outlets, the first spacing is between any two adjacent optical outlets in the plurality of optical outlets, and one of the optical outlets of the optical splitter is adjacent to one of the optical outlets of an adjacent optical splitter and has a second spacing; The second spacing is greater than the first spacing; The optical offset panel is configured to shorten the second spacing between the optical paths emitted by the two adjacent optical outlets between two adjacent splitters.

### BRIEF DESCRIPTION OF THE DRAWINGS

In order to more clearly illustrate the technical solutions of the embodiments of the present disclosure, the drawings required to be used in the embodiments or prior art descriptions will be briefly introduced below, and it is obvious that the drawings described below are only some embodiments of the present disclosure, and for those skilled in the art, other drawings can be obtained according to these drawings without creative labor.

FIG. 1 is a partial structural diagram of the optical communication system provided according to the embodiment of the present disclosure.

FIG. 2 is a local structure diagram of the host computer provided according to the embodiment of the present disclosure;

FIG. 3 is a structural diagram of an optical module provided according to the embodiment of the present disclosure;

FIG. 4 is an exploded view of the optical module provided according to the embodiment of the present disclosure;

FIG. 5 is an assembly drawing of the optical transceiver component and the circuit board in the optical module provided according to the embodiment of the present disclosure at another viewing angle;

FIG. 6 is an exploded view of the optical transceiver component and the circuit board in the optical module provided according to the embodiment of the present disclosure at another viewing angle;

FIG. 7 is another exploded view of the optical transceiver component and the circuit board in the optical module provided according to the embodiment of the present disclosure at another viewing angle;

FIG. 8 is another exploded view of the optical transceiver component and the circuit board in the optical module provided according to the embodiment of the present disclosure;

FIG. 9 is another exploded view of the optical transceiver component and the circuit board in the optical module provided according to the embodiment of the present disclosure;

FIG. 10 is an exploded view of the optical transceiver component in an optical module provided according to the embodiment of the present disclosure from another viewing angle;

FIG. 11 is an exploded view of the optical emitter and the transceiver body in the optical module provided according to the embodiment of the present disclosure;

FIG. 12 is a cross-sectional view of the optical transceiver component and the circuit board in another angle of view provided according to the embodiment of the present disclosure;

FIG. 13 is an optical path diagram of the optical emitter in the optical module provided according to the embodiment of the present disclosure;

FIG. 14 is a structural diagram of the transceiver body in the optical module provided according to the embodiment of the present disclosure;

FIG. 15 is a structural diagram of the second emission cover plate in the optical module provided according to the embodiment of the present disclosure;

FIG. 16 is an assembly drawing of the transceiver body and the second emission cover plate in the optical module provided according to the embodiment of the present disclosure;

FIG. 17 is a structural diagram of the second emission cover plate in the optical module provided according to the embodiment of the present disclosure at another viewing angle;

FIG. 18 is an assembly drawing of the transceiver body and the second emission cover plate in the optical module provided according to the embodiment of the present disclosure at another viewing angle;

FIG. 19 is another structural diagram of the second emission cover plate in the optical module provided according to the embodiment of the present disclosure;

FIG. 20 is another structural diagram of the second emission cover plate in the optical module provided according to the embodiment of the present disclosure;

FIG. 21 is another structural diagram of the transceiver body in the optical module provided according to the embodiment of the present disclosure;

FIG. 22 is another assembly drawing of the transceiver body and the second emission cover plate in the optical module provided according to the embodiment of the present disclosure;

FIG. 23 is another assembly drawing of the transceiver body and the second emission cover plate in the optical module provided according to the embodiment of the present disclosure;

FIG. 24 is an exploded view of the optical receiving component in the optical module provided according to the embodiment of the present disclosure;

FIG. 25 is an exploded view of the optical receiver and the transceiver tube in the optical module provided according to the embodiment of the present disclosure;

FIG. 26 is a cross-sectional view of the optical transceiver component in the optical module provided according to the embodiment of the present disclosure;

FIG. 27 is a schematic diagram of the optical path offset sheet in the optical module provided according to the embodiment of the present disclosure;

FIG. 28 is an assembly drawing of a turning prism and a fourth lens group in an optical module provided according to the embodiment of the present disclosure;

FIG. 29 is an optical path diagram of the optical receiver in the optical module provided according to the embodiment of the present disclosure;

FIG. 30 is an optical path diagram of the optical receiver in the optical module at another viewing angle provided according to the embodiment of the present disclosure;

FIG. 31 is an assembly drawing of an optical receiver and a receiving substrate in an optical module provided according to the embodiment of the present disclosure;

FIG. 32 is another structural diagram of a receiving substrate in an optical module provided according to the embodiment of the present disclosure;

FIG. 33 is another assembly drawing of the optical receiver and the receiving substrate in the optical module provided according to the embodiment of the present disclosure;

FIG. 34 is an assembly drawing of an optical receiver and a transceiver tube in an optical module provided according to the embodiment of the present disclosure;

FIG. 35 is a structural diagram of the transceiver body in the optical module provided according to the embodiment of the present disclosure at another viewing angle;

FIG. 36 is a structural diagram of the second receiving cover plate in an optical module provided according to the embodiment of the present disclosure;

FIG. 37 is an assembly drawing of the transceiver body and the second receiving cover plate in the optical module provided according to the embodiment of the present disclosure;

FIG. 38 is a structural diagram of the second receiving cover plate in the optical module provided according to the embodiment of the present disclosure at another viewing angle;

FIG. 39 is an assembly drawing of the transceiver body and the second receiving cover plate in the optical module provided according to the embodiment of the present disclosure at another viewing angle;

FIG. 40 is a structural diagram of the transceiver body in the optical module provided according to the embodiment of the present disclosure at another viewing angle;

FIG. 41 is a structural diagram of the fixing member in the optical module provided according to the embodiment of the present disclosure;

FIG. 42 is another assembly drawing of the optical receiver and the transceiver body in the optical module provided according to the embodiment of the present disclosure.

### DETAILED DESCRIPTION OF THE EMBODIMENTS

Some embodiments of the present disclosure are described clearly and in detail below, in conjunction with the accompanying drawings. However, the described embodiments are only some embodiments of the present disclosure, not all embodiments. Based on the embodiments provided in the present disclosure, all other embodiments obtained by a person skilled in the art fall within the scope of protection of the present disclosure.

Unless the context otherwise requires, throughout the description and claims, the term “including” is construed to mean open, inclusive, i.e., “including, but not limited to”; The terms “first”, “second” cannot be construed as indicating or implying relative importance or an upper limit on the number of indications; The term “multiple” means two or more; The term “connection” should be understood broadly, for example, “connection” may be fixed, detachable, or integral, directly or indirectly through an intermediary; The use of the terms “suitable for” or “configured to” implies open and inclusive language, which does not exclude devices that are applicable to or configured to perform additional tasks or steps; The terms “parallel”, “perpendicular”, “identical”, “equal”, “consistent”, “flush”, etc., are not limited to absolute mathematical theoretical relationships, but also include acceptable margin of error in practice, as well as differences based on the same design concept but due to manufacturing reasons.

In optical communication technology, in order to establish information transmission between information processing devices, it is necessary to load information onto light and use the propagation of light to realize the transmission of information. Here, the light loaded with information is the light signal. When optical signals are transmitted in information transmission equipment, the loss of optical power can be reduced, so high-speed, long-distance, and low-cost information transmission can be realized. The signals that information processing devices are able to recognize and process are electrical signals. Information processing equipment usually includes optical network units (ONU), gateways, routers, switches, mobile phones, computers, servers, tablet computers, televisions, etc., and information transmission equipment usually includes optical fibers and optical waveguides.

The optical module can realize the mutual conversion of optical signals and electrical signals between information processing equipment and information transmission equipment. For example, at least one of the optical signal input or optical signal output terminals of an optical module is connected with an optical fiber, and at least one of the electrical signal input terminals or electrical signal output terminals of an optical module is connected to an optical network terminal; the first optical signal from the optical fiber is transmitted to the optical module, and the optical module converts the first optical signal into the first electrical signal and transmits the first electrical signal to the optical network terminal; The second electrical signal from the optical network terminal is transmitted to the optical module, which converts the second electrical signal into a second optical signal and transmits the second optical signal to the optical fiber. Since information can be transmitted through electrical signals between a plurality of information processing devices, at least one information processing device in a plurality of information processing devices is required to be directly connected with the optical module, and all information processing devices are not required to be directly connected to the optical module. Here, the information processing device directly connected to the optical module is called the host computer of the optical module. In addition, the optical signal input or output of an optical module can be called an optical port, and the electrical signal input or output of an optical module can be called an electrical port.

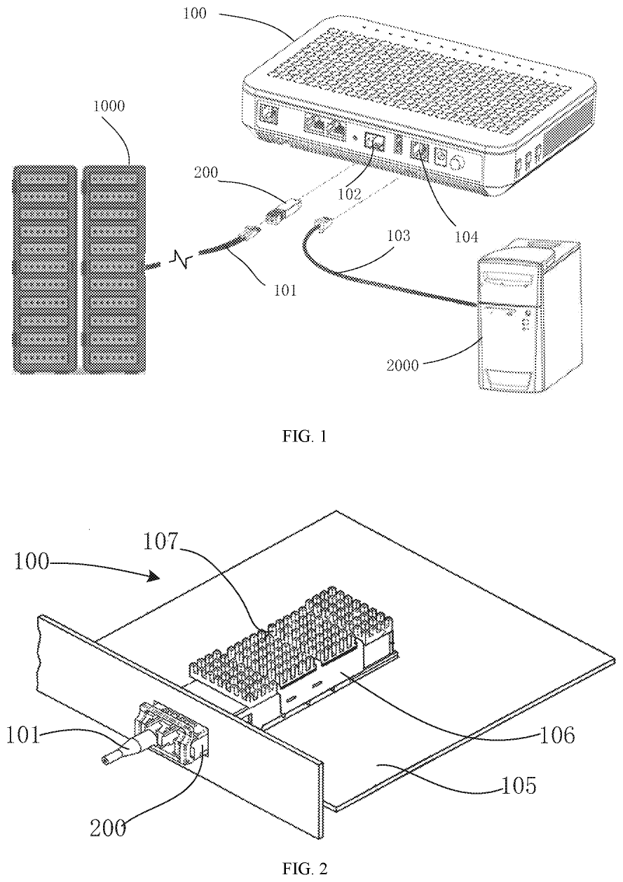

FIG. 1 is a partial structural diagram of the optical communication system provided according to the embodiments of the present disclosure. As shown in FIG. 1, the optical communication system mainly comprises a remote information processing device 1000, a local information processing device 2000, a host computer 100, an optical module 200, an optical fiber 101 and a network cable 103.

One end of the optical fiber 101 extends in the direction of the remote information processing device 1000, and the other end of the optical fiber 101 is connected with the optical module 200 through the optical port of the optical module 200. The optical signal can be fully reflected in the optical fiber 101, and the propagation of the optical signal in the direction of total reflection can almost maintain the original optical power, and the optical signal occurs many times of total reflection in the optical fiber 101 to transmit the optical signal from the remote information processing equipment 1000 to the optical module 200, or the optical signal from the optical module 200 is transmitted to the remote information processing equipment 1000, so as to realize the information transmission of long-distance and low power loss.

The optical communication system may include one or more optical fibers 101, and the optical fibers 101 are detachably connected with the optical module 200, or fixedly connected. The host computer 100 is configured to provide data signals to the optical module 200, or receive data signals from the optical module 200, or monitor or control the working state of the optical module 200.

The host computer 100 comprises a housing (housing) that is roughly a cuboid and an optical module interface 102 arranged on the housing. The optical module interface 102 is configured to access the optical module 200 so that the host computer 100 establishes a one-way or two-way electrical signal connection with the optical module 200.

The host computer 100 further comprises an external electrical interface, and this external electrical interface can be connected to an electrical signal network. For example, this external electrical interface comprises a universal serial bus interface (USB) or a network cable interface 104, and the network cable interface 104 is configured to access the network cable 103 so that the host computer 100 establishes a one-way or two-way electrical signal connection with the network cable 103. One end of the network cable 103 is connected to the local information processing device 2000, and the other end of the network cable 103 is connected to the host computer 100, so that an electrical signal connection is established between the local information processing device 2000 and the host computer 100 through the network cable 103. For example, the third electrical signal sent by the local information processing device 2000 is transmitted to the host computer 100 through a network cable 103, the host computer 100 generates a second electrical signal according to the third electrical signal, the second electrical signal from the host computer 100 is transmitted to the optical module 200, the optical module 200 converts the second electrical signal into a second optical signal, transmits the second optical signal to the optical fiber 101, and the second optical signal is transmitted to the remote information processing device 1000 in the optical fiber 101. For example, the first optical signal from the remote information processing device 1000 propagates through the optical fiber 101, the first optical signal from the optical fiber 101 is transmitted to the optical module 200, the optical module 200 converts the first optical signal into a first electrical signal, the optical module 200 transmits the first electrical signal to the host computer 100, the host computer 100 generates a fourth electrical signal according to the first electrical signal, and the fourth electrical signal is transmitted to the local information processing equipment 2000. It should be noted that the optical module is a tool to realize the mutual conversion of optical signals and electrical signals, and in the conversion process of optical signals and electrical signals, the information does not change, and the encoding and decoding methods of the information can change.

In addition to comprising optical network terminals, the host computer 100 also comprises optical line terminals (OLT), optical network equipment (Optical Network Terminal, ONT), or data center servers, etc.

FIG. 2 is a partial structure diagram of the host computer provided according to the embodiment of the present disclosure. In order to clearly show the connection relationship between the optical module 200 and the host computer 100, FIG. 2 shows only the structure of the host computer 100 related to the optical module 200. As shown in FIG. 2, the host computer 100 further comprises a PCB circuit board 105 arranged in a housing, a cage 106 arranged on the surface of the PCB circuit board 105, a radiator 107 arranged on the cage 106, and an electrical connector arranged inside the cage 106. The electrical connector is configured to access the electrical port of the optical module 200; The radiator 107 has a convex structure such as fins that enlarge the heat dissipation area.

The optical module 200 is inserted into the cage 106 of the host computer 100, the optical module 200 is fixed by the cage 106, and the heat generated by the optical module 200 is conducted to the cage 106, and then diffused through the radiator 107. After the optical module 200 is inserted into the cage 106, the electrical port of the optical module 200 is connected with the electrical connector inside the cage 106, so that the optical module 200 establishes a bidirectional electrical signal connection with the host computer 100. In addition, the optical port of the optical module 200 is connected with the optical fiber 101, so that the optical module 200 and the optical fiber 101 establish a bidirectional optical signal connection.

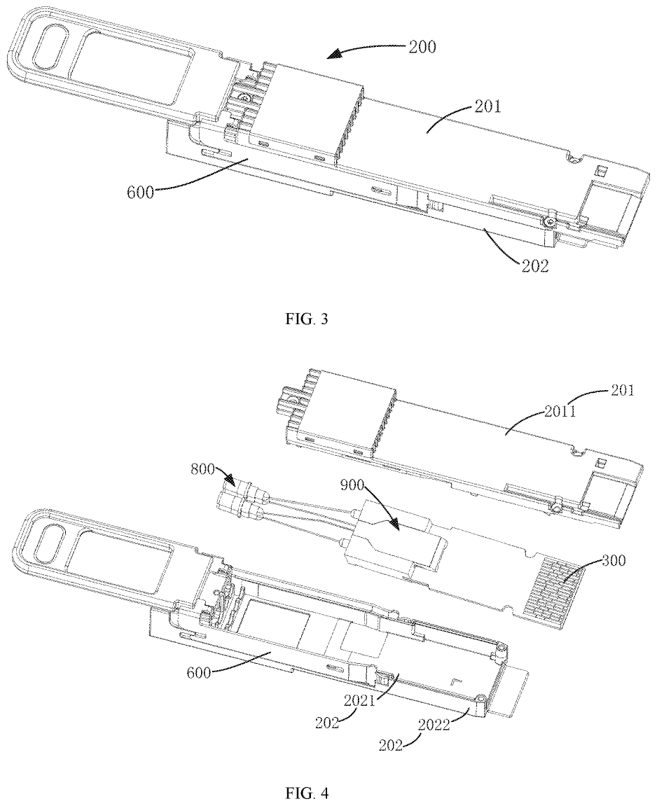

FIG. 3 is a structural diagram of an optical module provided according to the embodiment of the present disclosure, and FIG. 4 is an exploded view of an optical module provided according to the embodiment of the present disclosure. As shown in FIG. 3 and FIG. 4, the optical module 200 comprises a shell, a circuit board 300 arranged in the housing, and an optical transceiver part 900.

The shell comprises an upper shell 201 and a lower shell 202, and the upper shell 201 is covered on the lower shell 202 to form a shell with two openings 204 and 205; The outer contour of the shell is generally square.

In some embodiments, the lower housing 202 comprises a base plate 2021 and two lower side plates 2022 positioned on two sides of the bottom plate 2021 and perpendicular to the bottom plate 2021; The upper housing 201 comprises a cover plate 2011, and the cover plate 2011 is clasped on two lower side plates 2022 of the lower housing 202 to form the housing in question.

In some embodiments, the lower housing 202 comprises a base plate 2021 and two lower side plates 2022 positioned on two sides of the bottom plate 2021 and perpendicular to the bottom plate 2021; The upper housing 201 comprises a cover plate 2011 and two upper side plates positioned on two sides of the cover plate 2011 and perpendicular to the cover plate 2011, and is combined with two upper side plates and two lower side plates 2022 to realize that the upper housing 201 is covered and closed on the lower housing 202.

The connection direction of the two openings 204 and 205 can be consistent with the length of the optical module 200 or the length of the optical module 200. For example, opening 204 is located at the end of the optical module 200 (right end of FIG. 3), and opening 205 is also located at the end of the optical module 200 (left end of FIG. 3). Alternatively, the opening 204 is located at the end of the optical module 200, and the opening 205 is located at the side of the optical module 200. The opening 204 is an electrical port, and the gold finger of the circuit board 300 stretches out from the electrical port and is inserted into the electrical connector of the host computer 100; The opening 205 is an optical port and is configured to access an external optical fiber 101 so that the optical fiber 101 is connected to the optical transceiver component 900 in the optical module 200.

The assembly mode of combining the upper housing 201 and the lower housing 202 is adopted, so that the circuit board 300, the optical transceiver part 900, etc. are conveniently installed in the above-mentioned housing, and the above-mentioned device can be encapsulated and protected by the upper housing 201 and the lower housing 202. In addition, when assembling circuit board 300 and optical transceiver unit 900, it is convenient to deploy positioning parts, heat dissipation parts, and electromagnetic shielding parts of these devices, which is conducive to automated production.

In some embodiments, the upper housing 201 and the lower housing 202 are made of metal materials, which are conducive to electromagnetic shielding and heat dissipation.

In some embodiments, the optical module 200 further comprises an unlocking part 600 located outside its housing. The unlocking part 600 is configured to realize a fixed connection between the optical module 200 and the host computer, or to release the fixed connection between the optical module 200 and the host computer.

For example, the unlocking part 600 is located on the outer side of the two lower side plates 2022 of the lower housing 202 and comprises a clamping part matching the cage 106 of the upper computer 100. when the optical module 200 is inserted into the cage 106, the optical module 200 is fixed in the cage 106 by the clamping part of the unlocking part 600; When the unlocking part 600 is pulled, the clamping part of the unlocking part 600 moves accordingly, so that the connection relationship between the clamping part and the host computer is changed, so that the optical module 200 and the host computer are not fixed, so that the optical module 200 can be withdrawn from the cage 106.

The circuit board 300 comprises circuit wiring, electronic components and chips, etc., and electronic components and chips are connected according to the circuit design through circuit traces to realize functions such as power supply, electrical signal transmission and grounding. Electronic components can include, for example, capacitors, resistors, transistors, and metal-oxide-semiconductor field-effect transistors (MOSFETs). Examples of chips can include microcontroller units (MCUs), laser driver chips, transimpedance amplifiers (TIAs), limiting amplifiers, clock and data recovery chips (CDRs), power management chips, and digital signal processing (Digital). Signal Processing (DSP) chip.

The circuit board 300 is generally a rigid circuit board, and the rigid circuit board can also realize the bearing effect because of its relatively hard material, such as the rigid circuit board can smoothly carry the above-mentioned electronic components and chips; The rigid circuit board can also be inserted into the electrical connector in the cage 106 of the host computer 100.

The board 300 also includes gold fingers formed on the surface of its ends, which are made up of multiple pins that are independent of each other. The circuit board 300 is inserted into the cage 106 and is conducted by a gold finger with an electrical connector in the cage 106. The gold finger can be set only on the surface of one side of the board 300 (such as the upper surface shown in FIG. 4), or it can be set on the surface of the upper and lower sides of the board 300 to provide more pins and adapt to the situation where the number of pins is large. The gold finger is configured to establish an electrical connection with the host computer to achieve power supply, grounding, two-wire synchronous serial (I2C) signal transmission, data signal transmission, etc. Of course, flexible circuit boards are also used in some optical modules. Flexible circuit boards are generally used in conjunction with rigid circuit boards as a supplement to rigid circuit boards.

As shown in FIG. 4, a fiber optic connector group 800 is arranged in the housing, and the optical fiber connector group 800 is connected with an optical transceiver assembly 900. In some embodiments, the optical fiber connector group 800 comprises a plurality of first optical fiber connectors and a plurality of second optical fiber connectors, the first optical fiber connectors are stacked up and down with the second optical fiber connectors, the first optical fiber connectors are optical fiber connectors connected with the optical transmitter of the optical transceiver assembly 900, the second optical fiber connectors are connected with the optical receivers of the optical transceiver parts 900, and the first optical fiber connectors are connected with the optical transmitters of the optical transceiver parts 900 through optical fibers, The second optical fiber connector is connected with the optical receiver of the optical transceiver unit 900 through optical fiber.

In some embodiments, an electric chip is arranged on the upper surface of the circuit board 300, the electric chip has a transimpedance amplification function, and the two adjacent first electrical connection points of the electric chip are equally spaced. For example, if the electrical chip is a DSP chip, a TIA chip is integrated in the DSP chip, and the first electrical connection points of the DSP chip are regularly arranged, then the two adjacent first electrical connection points of the DSP chip are equally spaced, wherein the first electrical connection point of the DSP chip corresponds to the TIA chip in the DSP.

In some embodiments of the present disclosure, an optical path offset panel is arranged behind the splitter group, and the optical path spacing emitted by two adjacent optical outlets between the adjacent two splitters is shortened through the optical path offset panel set. Wherein, the adjacent two optical outlets between the two adjacent demultiplexers refer to the optical outlet closest to the second demultiplexer of the first demultiplexer of the two adjacent demultiplexers and the optical outlet closest to the first demultiplexer of the second demultiplexer of the two adjacent demultiplexers, that is, the optical outlet closest to the second demultiplexer of the first demultiplexer of the first two adjacent demultiplexers and the optical outlet closest to the first demultiplexer of the second demultiplexer of the two adjacent demultiplexers, and the first electrical connection point of the electrical chip is connected with the first pad of the optical receiving chip group.

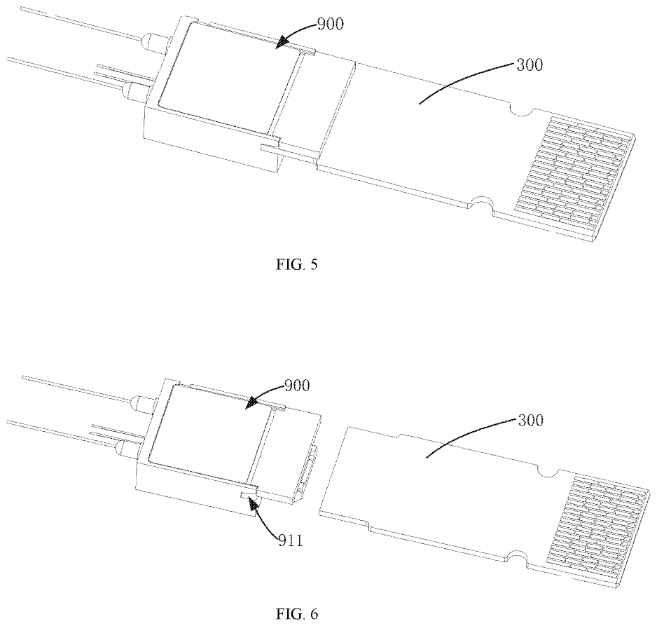

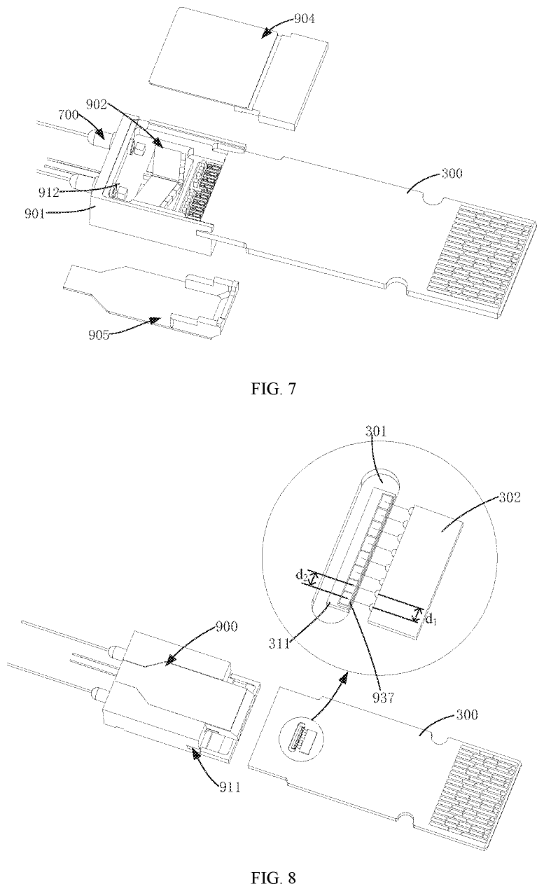

FIG. 5 is an assembly drawing of the optical transceiver component and the circuit board in the optical module provided according to the embodiment of the present disclosure at another viewing angle, FIG. 6 is an exploded view of the optical transceiver component and the circuit board in the optical module provided according to the embodiment of the present disclosure at another viewing angle, and FIG. 7 is another exploded view of the optical transceiver component and the circuit board in the optical module provided according to the embodiment of the present disclosure at another viewing angle. As shown in FIG. 5, FIG. 6 and FIG. 7, in some embodiments, the first end of the optical transceiver assembly 900 is provided with a first notch 911, that is, one end of the optical transceiver component 900 close to the circuit board 300 is provided with a first notch 911, and the circuit board 300 is clamped at the first notch 911 to realize the fixed connection between the optical transceiver component 900 and the circuit board 300.

In some examples, the optical transceiver part 900 can also be connected with the circuit board 300 through a flexible circuit board, that is, the circuit board 300 and the optical transceiver part 900 can not be fixedly connected, but the electrical signal on the circuit board 300 is transmitted to the optical transceiver part 900 through the flexible circuit board, and the electrical signal is converted into an optical signal in the optical transceiver part 900; Or the optical transceiver component 900 converts the optical signal into an electrical signal, and the electrical signal is transmitted to the circuit board 300 through the flexible circuit board, and is transmitted to the host computer through the circuit board 300.

In some embodiments, the optical transceiver assembly 900 comprises a transceiver body 901, a transmitting cover plate 904 and a receiving cover plate 905, and the transmitting cover plate 904 is closed on the lower surface of the transceiver body 901 (taking the viewing angle in FIG. 7 as an example, the present disclosed embodiment may refer to the upper surface of the transceiver body 901 in FIG. 7) and the lower surface of the circuit board 300 to form a transmitting cavity; The receiving cover plate 905 is closed on the upper surface of the transceiver body 901 (taking the viewing angle in FIG. 7 as an example, the embodiment of the present disclosure may refer to the lower surface of the transceiver body 901 in FIG. 7) and the upper surface of the circuit board 300 to form a receiving cavity. A transmitting groove 912 is arranged in the transmitting cavity, that is, the lower surface of the transceiver body 901 (one side of the transceiver body 901 facing the launch cover plate 904) is provided with a transmitting groove 912, and an optical emitter 902 is arranged in the transmitting groove 912, so as to realize the emission of the optical signal.

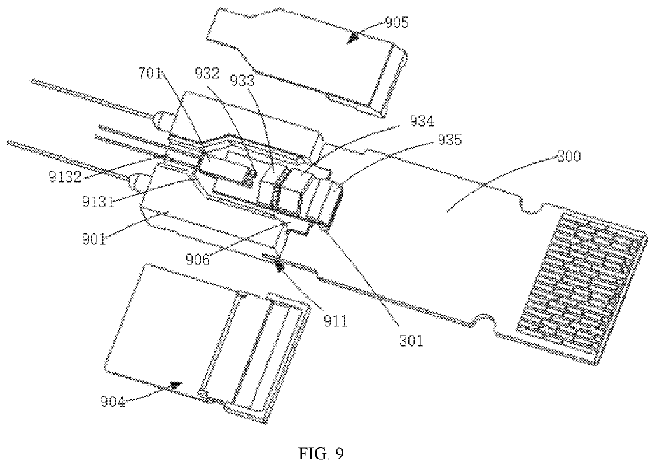

FIG. 8 is another exploded view of the optical transceiver component and the circuit board in the optical module provided according to the embodiment of the present disclosure, and FIG. 9 is another exploded view of the optical transceiver component and the circuit board in the optical module provided according to the embodiment of the present disclosure. As shown in FIG. 8 and FIG. 9, in some embodiments of the present disclosure, a receiving groove 913 is arranged in the receiving cavity, that is, a receiving groove 913 is arranged on the upper surface of the transceiver body 901 (one side of the transceiver body 901 facing the receiving cover plate 905), and a portion of the optical receiver 903 is arranged in the receiving groove 913 to realize optical signal reception.

As shown in FIG. 8, in some embodiments, an optical receiving chip group 937 is arranged on the upper surface of the circuit board 300, and the optical receiving chip group 937 converts the received optical signal into an electrical signal. The optical receiving chip group 937 comprises a plurality of optical receiving chips arranged in parallel, and the first pads of the two adjacent optical receiving chips are equally spaced. For example, the optical receiver chip group 937 comprises eight optical receiver chips arranged in parallel with two adjacent optical receiver chips with equal first pad spacing and d2.

As shown in FIG. 8, the upper surface of the circuit board 300 is also provided with a digital signal processing (Digital Signal Process, referred to as DSP) chip 302, and the DSP chip 302 is wired with optical transmitter 902 and optical receiver 903 respectively. The host computer transmits the electrical signal to the DSP chip 302 through the gold finger, the DSP chip 302 processes the electrical signal, the laser driver chip sends out the driving current according to the processed electrical signal, and the optical transmitter 902 emits the optical signal after receiving the driving current. The optical receiver 903 converts the received optical signal into an electrical signal, and the DSP chip 302 processes the electrical signal, and the processed electrical signal is transmitted to the host computer through a gold finger.

In some embodiments, a TIA chip is integrated in the DSP chip 302, and the power supply circuit that supplies power to the TIA chip can also supply power to other devices in the DSP chip 302, reduces the power supply circuit inside the DSP chip 302, and effectively reduces power consumption.

The DSP chip 302 is integrated with a TIA chip, and the first electrical connection points of the DSP chip 302 are regularly arranged, so that the spacing of the two adjacent first electrical connection points of the DSP chip 302 is equal. For example, the spacing of the two adjacent first electrical connection points of the DSP chip 302 is d1, and the first pad spacing of the two adjacent optical receiving chips of the optical receiving chip group 937 is d1. However, since the first pad spacing of the optical receiving chip can only be d2 at present, the first pad spacing of any two adjacent optical receiving chips of the optical receiving chip group 937 can be d2. In this way, the first pad spacing of the adjacent two optical receiving chips of the optical receiving chip group 937 is equal, so that the bonding distance between the first electrical connection point of the DSP chip 302 and the first pad of the optical receiving chip group 937 is shortened, the loss of high-frequency signal on the bonding line is reduced, and the high-frequency performance of the optical module is ensured in turn.

In some embodiments, the DSP chip 302 can be flip chip, that is, the DSP chip 302 and the circuit board 300 can be connected through a solder ball. For example, a solder ball layer may be arranged on the lower surface of the DSP chip 302, the solder ball layer may include a variety of solder balls, one of which is the first solder ball corresponding to the TIA chip, a second solder ball is arranged on the upper surface of the circuit board 300, and the second solder ball is connected with other solder balls other than the first solder ball in the solder ball layer.

Because the DSP chip 302 is integrated with a TIA chip, the connection between the optical receiving chip group 937 and the TIA chip becomes the connection of the first solder ball of the optical receiving chip group 937 and the DSP chip 302, and the spacing of the two adjacent first electrical connection points of the DSP chip 302 is the spacing of the two adjacent first solder balls of the DSP chip 302. For example, the spacing of the two adjacent first bumps of the DSP chip 302 is d1.

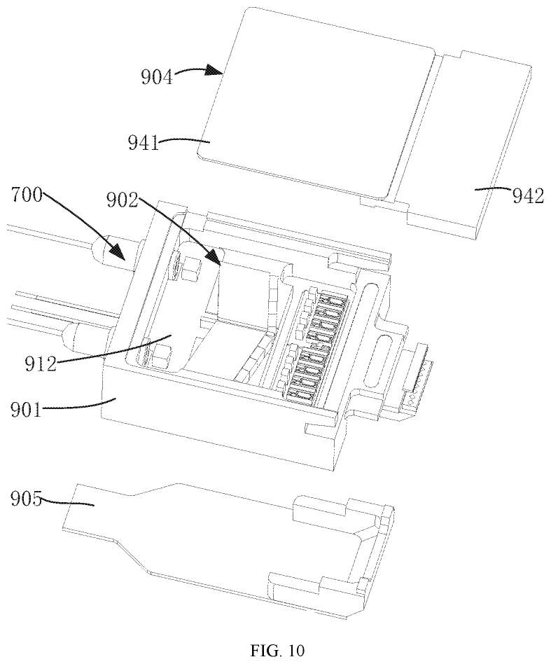

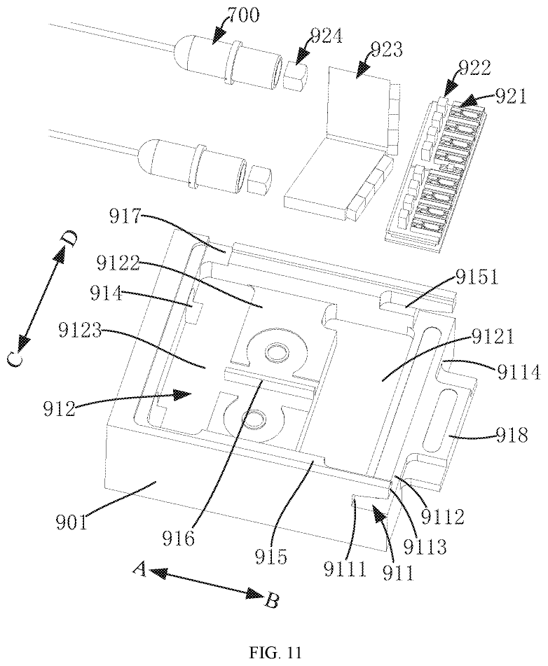

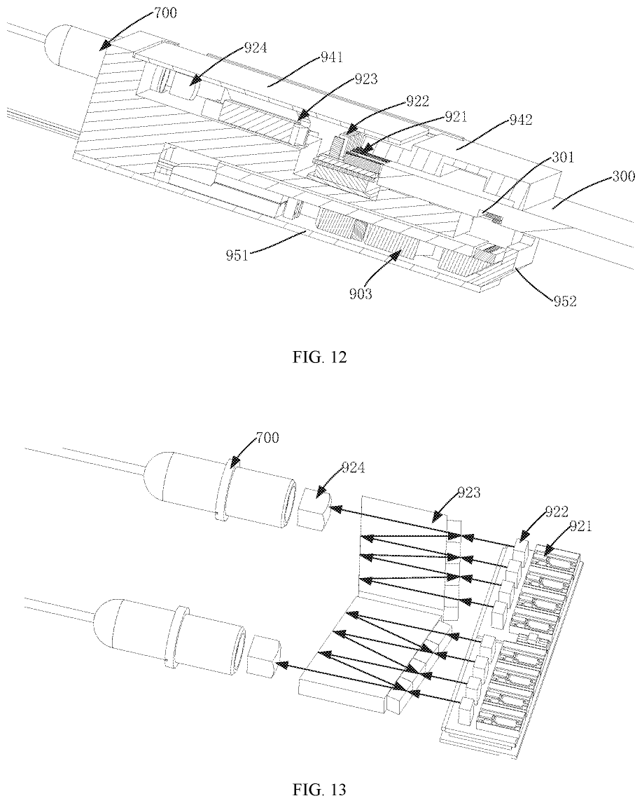

FIG. 10 is an exploded view of the optical transceiver component in an optical module provided according to the embodiment of the present disclosure from another viewing angle, FIG. 11 is an exploded view of the optical emitter and the transceiver tube in the optical module provided according to the embodiment of the present disclosure, and FIG. 12 is a cross-sectional view of the optical transceiver component and the circuit board in the optical module provided according to the embodiment of the present disclosure from another viewing angle. As shown in FIG. 10, FIG. 11 and FIG. 12, in some embodiments, the optical emitter 902 comprises a laser chip group 921, a first lens set 922, a combiner set 923, a second lens group 924 and an emitting optical fiber adapter set 700, the first lens group 922 is located between the laser chip group 921 and the multiplexer group 923, and the second lens group 924 is located between the multiplexer group 923 and the transmitting optical fiber adapter group 700.

In some embodiments, the laser chip group 921 comprises a plurality of laser chips arranged in parallel. For example, the laser chip group 921 comprises eight laser chips arranged in parallel, which are 100G (in the embodiment of the present disclosure are only used as a distance description and are not a specific limitation on the laser chip) EML chip. A 100G EML chip emits one 100G optical signal according to the driving current, so that the laser chip group 921 emits eight 100G optical signals of different wavelengths, that is, the laser chip group 921 emits 800G optical signals.

In some embodiments, the first lens group 922 comprises a plurality of collimating lenses arranged in parallel. For example, the first lens group 922 comprises eight collimating lenses arranged in parallel, and the collimating lenses are arranged corresponding to the laser chip. Eight 100G optical signals of different wavelengths emitted by the laser chip group 921 are collimated by the first lens set 922.

In some embodiments, the multiplexer group 923 comprises a plurality of combiners arranged in parallel. For example, the combiner set 923 comprises two combiners arranged in parallel, one combiner corresponding to four laser chips and four collimating lenses. Eight channels of 100G collimated optical signals are combined into two channels of 400G optical signals by the multiplexer group 923.

In some embodiments, the second lens group 924 comprises a plurality of focusing lenses arranged in parallel. For example, the second lens group 924 consists of two focusing lenses set up side by side.

In some embodiments of the present disclosure, the transmitting fiber adapter set 700 comprises a plurality of transmitting fiber adapters arranged in parallel. For example, the transmit fiber adapter set 700 includes two transmit fiber adapters arranged in parallel, and the combiner, focusing lens, and transmit fiber adapter are set up accordingly. The second lens group 924 focuses two 400G optical signals to the transmitting fiber adapter set 700 respectively.

As shown in FIG. 11 and FIG. 12, in some embodiments of the present disclosure, the optical emission slot 912 comprises a first emission slot portion 9121, a second emission slot portion 9122 and a third emitting slot portion 9123, the second emitting slot portion 9122 is located between the first emitting slot portion 9121 and the third emitting slot portion 9123, and the first emitting slot portion 9121 is closer to the circuit board 300 relative to the other emitting slots, The third emission slot 9123 is farther away from the circuit board 300 than the other emission slots, the laser chip group 921 and the first lens group 922 are placed in the first emission slot 9121, the multiplexer group 923 is placed in the second emission slot 9122, and the second lens group 924 is placed in the third emission slot 9123.

In some embodiments of the present disclosure, the laser chips of the laser chip group 921 are all chip on a carrier (Chip On carrier, COC), which can also be called chip placement on a porcelain substrate. Therefore, the side contours of each laser chip of the laser chip group 921 are relatively regular, for example, the side contours of each laser chip of the laser chip group 921 are rectangular respectively.

In order to control the temperature of the laser chip group 921 so that the optical signal emitted by the laser chip group 921 is stable, in some embodiments of the present disclosure, a semiconductor cooler (Thermo Electric Cooler, TEC) is arranged in the first emission slot 9121, an emission substrate is arranged on the TEC, and a laser chip group 921 and a first lens group 922 are placed on the emission substrate. The TEC is located below the laser chip group 921 (taking the direction shown in FIG. 11 as an example, in some examples, it can also be understood that the TEC is located in the laser chip group 921 facing the first emission slot 9121) to adjust the temperature of the laser chip group 921.

In some embodiments, the multiplexer group 923 is bonded into the second emission groove portion 9122. In order to facilitate the control of the glue of the multiplexer group 923 and the second emitting groove 9122, a circular dispensing groove is arranged on the upper surface of the second transmitter groove 9122. Dispensing in a circular dispensing tank is not only convenient for controlling the amount of glue, but also for controlling glue stress.

In order to improve the coupling efficiency, in some embodiments, the height of the first launch groove 9121 (illustrated by taking the height direction shown in FIG. 11 as an example) is smaller than that of the second emitting groove 9122 (referring to FIG. 11, that is, the depth of the depression of the first emitting groove 9121 from the surface of the transceiver body 901 is greater than the depression depth of the second emitting groove 9122), so that the central axis of the first lens group 922 arranged in the first emission slot 9121 coincides with the optical inlet of the multiplexer group 923 arranged in the second emission slot 9122, so that the multiplexer group 923 receives as much as possible the optical signal after collimation of the first lens group 922, thereby improving the coupling efficiency.

In order to improve the coupling efficiency, in some embodiments, the height of the second transmitting slot 9122 (illustrated by taking the height direction shown in FIG. 11 as an example) is greater than the height of the third emitting slot 9123 (in other words, the depth of the depression of the second emitting slot 9122 from the surface of the transceiver body 901 is less than the depression depth of the second emitting slot 9122), so that the light outlet of the multiplexer group 923 arranged in the second emission slot 9122 coincides with the central axis of the second lens group 924 arranged in the third emission slot 9123, so that the second lens group 924 receives as much optical signals as possible from the multiplexer group 923, so that the coupling efficiency is improved.

In order to improve the coupling efficiency, in some embodiments, the height of the third launch groove 9123 (specified in the height direction shown in FIG. 11 as a specific example) is greater than the height of the first launch groove 9121 (in other words, the depth of the depression of the third launch groove 9123 from the surface of the transceiver body 901 is less than the depression depth of the first launch groove 9121). so that the height of the central axis of the first lens group 922 of the first emission slot 9121, the optical inlet of the multiplexer group 923 arranged in the second emission slot 9122 and the central axis of the second lens group 924 arranged in the third emission slot 9123 coincide, so that the second lens group 924 receives as many optical signals emitted by the laser chip set 921 as possible, thereby improving the coupling efficiency.

As shown in FIG. 11, in some embodiments of the present disclosure, a bearing piece 916 is arranged on the second transmitting groove portion 9122 along the length direction of the transceiver body 901 (for example, with reference to FIG. 11, arrows A to B directions in FIG. 11 are the length direction of the transceiver body 901), and the bearing piece 916 is located between the two combiners to carry the multiplexer group 923. That is, the two opposite sides of the carrier 916 respectively carry an a wave combiner. For example, one side of the carrier 916 carries a combiner of the multiplexer group 923, and the other side of the carrier 916 carries another combiner of the multiplexer group 923, wherein one side of the carrier 916 and the other side of the carrier 916 are arranged opposite each other. The setting of the carrier part 916 is not only convenient for identifying the mounting position of the multiplexer group 923, but also convenient for the placement of the multiplexer group 923, so as to improve the placement accuracy of the multiplexer group 923, avoid the deviation of the multiplexer group 923 from the preset position, and improve the coupling efficiency. As shown in FIG. 11, in some embodiments, the second end of the transceiver body 901 is provided with a placement through hole 914, and the placement through hole 914 is configured to place a transmitting optical fiber adapter (with reference to FIG. 12). The object through hole 914 is correspondingly arranged with the focusing lens of the second lens group 924 so that the transmitting fiber adapter receives the optical signal after coupling the focusing lens of the second lens group 924.

As shown in FIG. 11, in some embodiments, the first end of the transceiver body 901 is provided with a first notch 911, specifically, The two oppositely arranged side walls are concave in the direction away from the circuit board 300 to form a first notch 911, the first notch 911 comprises a bottom surface 9111, a first side surface 9112 and a second side surface, the first side 9112 and the second side surface are arranged oppositely, and the first side surface 9112, the bottom surface 9111 and the second side surface form a U-shaped groove to facilitate the insertion of the circuit board 300. The circuit board 300 is inserted into the first notch 911 of the transceiver body 901, the upper surface of the circuit board 300 (i.e., the side of the circuit board 300 facing the transmitting groove 912) is in contact with the first side 9112, and the lower surface of the circuit board 300 (i.e., the side of the circuit board 300 facing the transmitting groove 912) is in contact with the second side side, so that the circuit board 300 is fixedly connected with the transceiver body 901.

the first notch 911 divides the end face of the first end of the transceiver body 901 into a first end face 9113 and a second end face 9114, the first end face 9113 is connected with the second side side, and the first end face 9113 is located below the first notch 911 (it can be understood here that when the optical module provided in the embodiment of the present disclosure is in normal use, the first end face 9113 is located below the first notch 911, wherein FIG. 11 is illustrated as an example, with reference to FIG. 11, the first end face 9113 may be located above the first notch 911 in FIG. 11), the second end face 9114 is connected with the first side 9112, and the second end face 9114 is located above the first notch 911 (it can be understood here that when the optical module provided in the embodiment of the present disclosure is in normal use, the first end face 9113 is located above the first notch 911, wherein FIG. 11 is illustrated as an example, with reference to FIG. 11, The first end face 9113 can be located below the first notch 911 in FIG. 11), the second end face 9114 is provided with a support 918 protruding outward, one side of the support 918 towards the circuit board 300 is flush with the first side 9112, and one side of the support 918 towards the circuit board 300 and the first side surface 9112 of the first notch 911 are respectively connected with the upper surface of the circuit board 300. In this way, the contact area between the first side 9112 and the circuit board 300 can be increased, and the stability of the connection between the circuit board 300 and the transceiver body 901 can be effectively improved.

As shown in FIG. 11, in some embodiments, the lower surface of the transceiver pipe body 901 (located at the top in the up-down direction shown in FIG. 11) is provided with a first card junction 915, the first clamp junction 915 is formed by a depression of each side wall of the transceiver body 901 towards the direction of the launch groove 912, and the first clamp junction surface 915 is enclosed with the side wall of the transmitting and receiving tube body 901 to form a first limiting notch. In other words, the first card junction 915 and the side wall extending out of the first card junction 915 in the transceiver pipe body 901 form the first limiting gap.

In some embodiments, the launch cover plate 904 is a one-piece structure. In order to facilitate the processing and assembly of the launch cover plate 904, with reference to FIG. 12, the launch cover plate 904 comprises a first launch cover plate 941 and a second launch cover plate 942, the first end cover of the first launch cover plate 941 is attached to the first engaging surface 915 on the lower surface of the transceiver body 901, and the side side of the first launch cover plate 941 is clamped on the inner surface of the side wall of the transceiver body 901, so that the first launch cover plate 941 is clamped at the first limiting notch; The second end of the first transmitting cover plate 941 is sealed on the first end of the second transmitting cover plate 942, the second transmitting cover plate 942 has a second notch, the first end end face of the side wall below the first notch 911 in the transceiver body 901 and the inner surface of the side wall below the first notch 911 in the transceiver body 901 are clamped into the second notch, and the second end of the second transmitting cover plate 942 is sealed on the lower surface of the circuit board 300, so that the transmitting cover plate 904 is covered on the transceiver body 901 and the circuit board 300. Wherein, the first end of the side wall below the first notch 911 in the transceiver body 901 refers to one end that the side wall below the first notch 911 in the transceiver body 901 (in the upper and lower bits shown in FIG. 11, it can be positioned above the first notch 911) is far away from the object through hole 914.

In order to make the first launch cover plate 941 hermetically connected with the transceiver body 901, in some embodiments, the shape of the first launch cover plate 941 matches the shape of the first clamp junction 915. For example, the shape of the first launch cover 941 is identical, similar or similar to the shape of the first card junction 915.

In order to avoid the electronic components on the circuit board 300, referring to FIG. 12, in some embodiments of the present disclosure, the end of the second emitting cover plate 942 (referring to FIG. 12, in the embodiments of the present disclosure, the end may refer to one end of the second emitting cover plate 942 towards the circuit board 300, or may also refer to one end of the second emitting cover plate 942 facing the through hole 914 of the backing object) extending out of the side wall of the transceiver body 901, The side facing the circuit board 300 in the second emission cover plate 942 is concave inward to form a first avoidance groove, and the depth of the first avoidance groove corresponds to the size of the corresponding electronic component on the circuit board 300, or, in some examples, the depth of the first avoidance groove may also be greater than the size of the corresponding electronic component on the circuit board 300, so that the electronic component on the circuit board 300 is avoided.

As shown in FIG. 11, in some embodiments, a rework port 917 is arranged on one side wall of the transceiver pipe body 901, and the height of the rework port 917 is lower than the height of the first card junction 915, that is, the depth of the depression of the rework port 917 when it is dented from the surface of the transceiver pipe body 901 is greater than the distance between the first card junction 915 and the surface of the transceiver pipe body 901. In this way, after the first launch cover plate 941 is clamped to the first card junction face 915 (or can also be understood to be clamped into the first limiting notch), there is a certain gap between the rework port 917 and the inner surface of the first launch cover plate 941, so that the first launch cover plate 941 can be pried open through the rework port 917. The rework port 917 is used as a reserved pry point to facilitate the rework of the optical transceiver part 900.

FIG. 13 is an optical path diagram of the optical emitter in the optical module provided according to the embodiment of the present disclosure. As shown in FIG. 13, in some embodiments of the present disclosure, the laser chip group 921 emits eight channels of 100G optical signals, and in the embodiments of the present disclosure, eight optical signals are taken as specific examples as examples, and it can be understood that in some examples, the optical signals may also be other multiple channels, and the embodiments of the present disclosure do not limit this. The eight-channel 100G optical signal is collimated through the first lens group 922, and the collimated eight-channel 100G optical signal is incident on the multiplexer group 923, the multiplexer group 923 combines the eight-channel 100G optical signal after changing position into two 400G optical signals, and the two 400G optical signals are focused and coupled to the transmitting optical fiber adapter group 700 through the second lens group 924.

In order to fix the circuit board 300 at the first notch 911, referring to the FIG. 11, in some embodiments, the first side side 9112 of the first notch 911 and the supporting piece 918 facing the circuit board 300 are provided with glue grooves, and glue is placed in the glue grooves to realize that the circuit board 300 is fixed at the first notch 911.

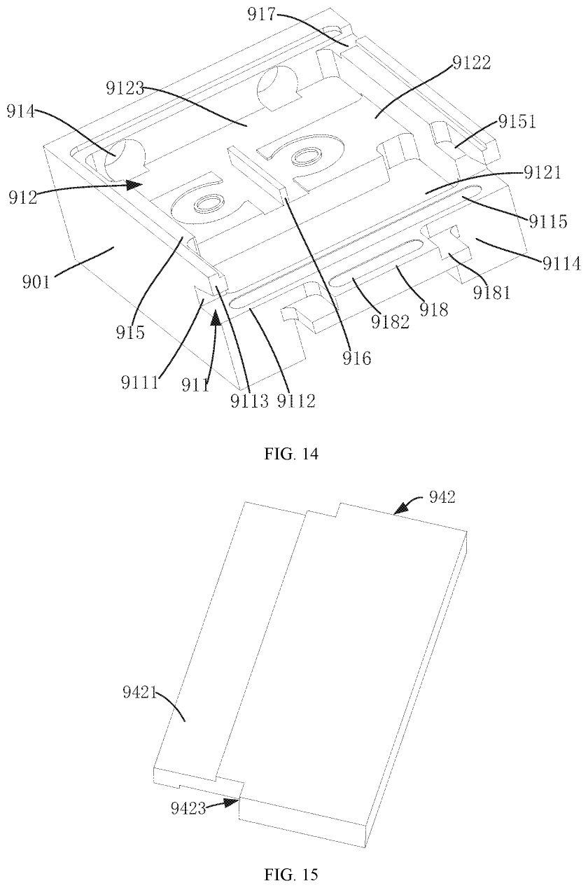

FIG. 14 is a structural diagram of the transceiver body in the optical module provided according to the embodiment of the present disclosure. As shown in FIG. 14, in order to fix the circuit board 300 at the first notch 911, in some embodiments, the first side of the first notch 911 of the transceiver body 901 9112 is provided with a first glue groove 9115, and a second is arranged on one side of the supporting piece 918 facing the circuit board 300 The glue groove 9182 is placed, and glue is injected into the first glue groove 9115 and the second glue groove 9182. After the circuit board 300 is inserted into the first notch 911, the glue in the first glue groove 9115 and the second glue groove 9182 is bonded to the circuit board 300 and the first notch 911 to realize the fixed connection between the circuit board 300 and the first notch 911.

In order to avoid the electronic components on the circuit board 300, in some embodiments, the two sides of the support 918 are provided with avoidance recesses 9181. Avoid the recess 9181 recesses the support 918 to avoid the electronic components on the circuit board 300.

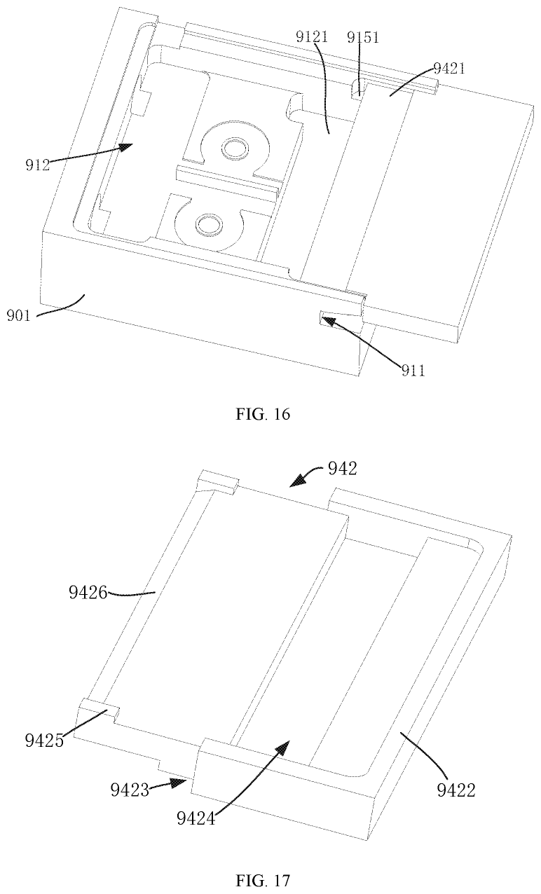

FIG. 15 is a structural diagram of the second emission cover plate in an optical module provided according to the embodiment of the present disclosure, and FIG. 16 is an assembly drawing of the transceiver body and the second emission cover plate in an optical module provided according to the embodiment of the present disclosure. As shown in FIG. 15 and FIG. 16, in some embodiments of the present disclosure, a depression on the first surface of the second transmitting cover plate 942 close to one end of the transceiver body 901 forms a support depression 9421 the support depression 9421 causes the first surface of the second launch cover plate 942 to be in the form of steps, and the second surface of the second end of the first launch cover plate 941 is placed on the support depression 9421 to support the first launch cover plate 941, so that the first launch cover plate 941 is hermetically connected with the second launch cover plate 942. The support depression 9421 is not only configured to support the first launch cover plate 941, but also configured to limit the position of the first launch cover plate 941, so as to facilitate the placement of the first launch cover plate 941 so as to improve the mounting accuracy of the first launch cover plate 941. Wherein, the first surface of the second transmitting cover plate 942 is one side away from the transceiver body 901, and the second surface of the second transmitting cover plate 942 is one side close to the transceiver body 901.

As shown in FIG. 15 and FIG. 16, in some embodiments of the present disclosure, the two sides of the second emission cover plate 942 are provided with a second notch 9423, the first side of the second notch 9423 and the second side of the second notch 9423 are enclosed to form an L-shaped notch, and the first side of the L-shaped notch is connected with the first end face 9113 of the transceiver pipe body 901, The second side of the L-shaped notch is connected with the inner surface of the side wall below the first notch 911 in the transceiver body 901 so as to realize the sealed connection between the transceiver body 901 and the second transmitting cover plate 942.

As shown in FIG. 14 and FIG. 16, in some embodiments, one end of the first engaging surface 915 close to the circuit board 300 continues to be concave to form a second engaging surface 9151, and the second engaging surface 9151 forms a second limiting gap enclosed by the side wall of the transceiver pipe body 901. The first end of the second launch cover plate 942 is covered on the second clamp junction surface 9151, and the side of the second launch cover plate 942 is correspondingly arranged with the side wall in the transceiver body 901, so that the second launch cover plate 942 is clamped at the second limiting notch.

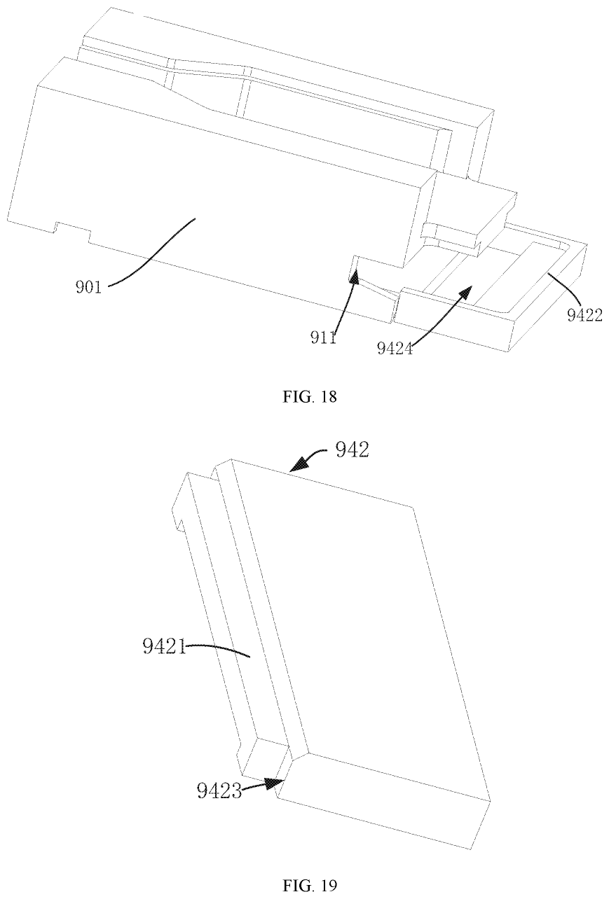

FIG. 17 is a structural diagram of the second emission cover plate in the optical module provided according to the embodiment of the present disclosure at another viewing angle, and FIG. 18 is an assembly drawing of the transceiver body and the second emission cover plate in the optical module provided according to the embodiment of the present disclosure at another viewing angle. As shown in FIG. 17 and FIG. 18, in some embodiments, the second surface of the second emitting cover plate 942, far away from one end of the first emitting cover plate 941, protrudes outwards to form a supporting protrusion 9422, and the supporting protrusion 9422 is in contact with the lower surface of the circuit board 300. The supporting protrusion 9422 causes only part of the lower surface of the second emission cover plate 942 to be in contact with the lower surface of the circuit board 300, so as to avoid the electronic components on the circuit board 300.

It can be understood that in other examples of the present disclosure, the support protrusion 9422 may also be arranged on the circuit board 300, and the protruding height of the supporting protrusion 9422 on the circuit board 300 is greater than or equal to the protruding height of the electronic components on the circuit board 300, so that the supporting protrusion 9422 can be supported on one side of the second emitting cover plate 942 facing the circuit board 300, so that the second emitting cover plate 942 avoids the electronic components on the circuit board 300.

As shown in FIG. 17 and FIG. 18, in some embodiments, two sides of one end of the second emitting cover plate 942 protruding outwards close to the first emitting cover plate 941 to form a first support boss 9425, the first support boss 9425 protrudes out of the second surface, and the first support boss 9425 is in contact with the second engaging surface 9151.

As shown in FIG. 17 and FIG. 18, in some embodiments of the present disclosure, the depth of the first avoidance groove 9424 is shallow at both ends and deep in the middle, that is, the shape of the first avoidance groove 9424 is U-shaped, so as to avoid the electronic components on the circuit board 300.

As shown in FIG. 17, in some embodiments, a second surface of the second emission cover plate 942 close to one end of the first emission cover plate 941 is provided with an avoidance surface 9426, and the avoidance surface 9426 has a first preset angle to prevent collision with the laser chip of the laser chip group 921 when assembling an optical module.

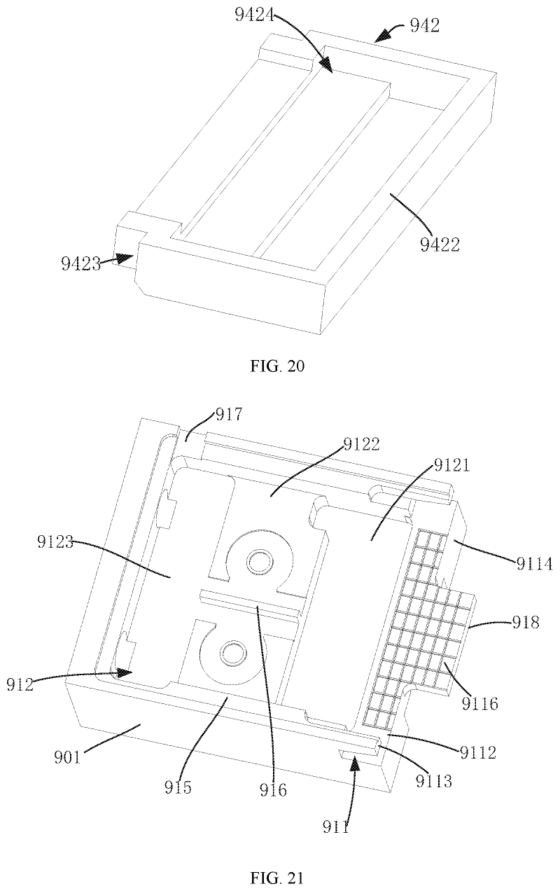

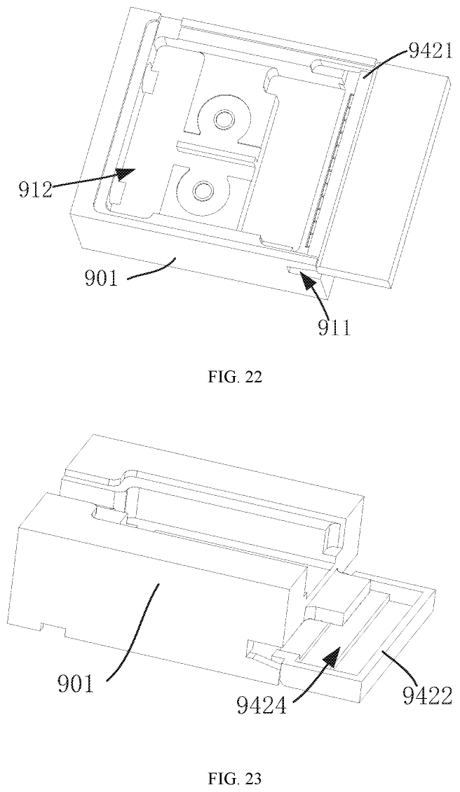

FIG. 19 is another structural drawing of the second emission cover plate of an optical module provided according to the embodiment of the present disclosure, FIG. 20 is another structural drawing of the second emission cover plate of an optical module provided according to the embodiment of the present disclosure, FIG. 21 is another structural drawing of the transceiver body of an optical module provided according to the embodiment of the present disclosure, and FIG. 22 is another assembly drawing of the transceiver body and the second emission cover plate of the optical module provided according to the embodiment of the present disclosure, FIG. 23 is another assembly drawing of the transceiver body and the second emission cover plate in the optical module provided according to the embodiment of the present disclosure.

As shown in FIG. 19-FIG. 23, in some embodiments of the present disclosure, the second transmitting cover plate 942 may be connected to the transceiver body 901 through the second notch 9423 only, so that the second transmitting cover plate 942 is hermetically connected with the transceiver body 901. That is, the first end of the second launch cover plate 942 is suspended, and the first end of the second launch cover plate 942 is no longer covered on the second card junction surface 9151.

As shown in FIG. 19-FIG. 23, the second emission cover plate 942 is provided with a support depression 9421, and the length of the support depression 9421 of the second emission cover plate 942 extending in the direction of the transceiver body 901 is shorter, so that the second emission cover plate 942 is far away from the top of the laser chip group 921, and the second emission cover plate 942 is reduced to collide with the connection between the laser chip group 921 and the DSP chip 302 on the circuit board 300.

As shown in FIG. 19-FIG. 23, the second emitting cover plate 942 is provided with a supporting protrusion 9422, and the supporting protrusion 9422 extends from the first end of the second emitting cover plate 942 to the second end of the second emitting cover plate 942, so that only part of the second surface of the second emitting cover plate 942 is in contact with the lower surface of the circuit board 300, so as to avoid the electronic components on the circuit board 300.

As shown in FIG. 19-FIG. 23, the second emission cover plate 942 is provided with a first avoidance groove 9424, and the shape of the first avoidance groove 9424 is stepped to avoid the electronic components on the circuit board 300.

As shown in FIG. 21, in some embodiments of the present disclosure, the two sides of the support 918 may also not avoid the depression, and the first side of the first notch 911 and the one side of the support 918 facing the circuit board 300 are provided with a plurality of thirds Place the glue tank 9116. A plurality of third glue grooves 9116 encloses one side of the first notch 911 and a supporting piece 918 facing the circuit board 300 to form a grid-like structure, glue is placed in the third glue groove 9116 in the grid-like structure, and each grid in the grid-like structure is also coated with glue. A plurality of third glue grooves 9116 encloses one side of the first notch 911 and the supporting piece 918 towards the circuit board 300 into a grid-like structure, not only ensures the amount of glue between the circuit board 300 and the transceiver body 901, but also increases the contact area between the circuit board 300 and the transceiver body 901, and then increases the adhesion force between the circuit board 300 and the transceiver body 901.

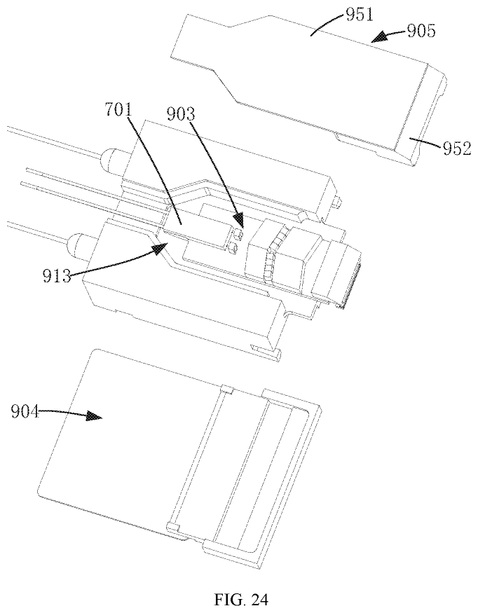

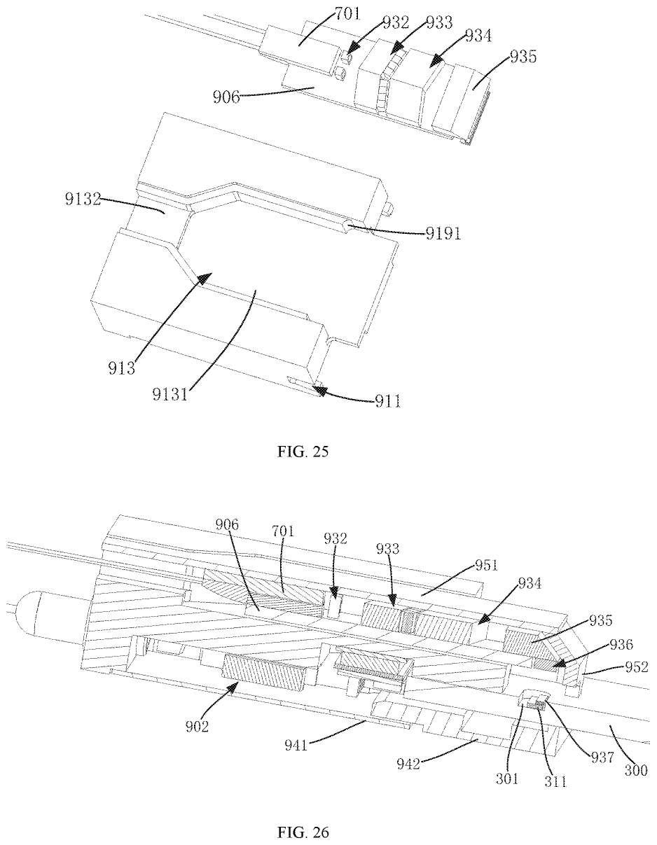

FIG. 24 is an exploded view of the optical receiving component in an optical module provided according to the embodiment of the present disclosure, FIG. 25 is an exploded view of the optical receiver and the transceiver tube in an optical module provided according to the embodiment of the present disclosure, and FIG. 26 is a cross-sectional view of the optical transceiver component in an optical module provided according to the embodiment of the present disclosure. As shown in FIG. 24-FIG. 26, in some embodiments of the present disclosure, the optical receiver 903 comprises an optical fiber collimator group, a demultiplexer group 933, a turning prism 935, a fourth lens group 936 and an optical receiving chip group 937, the demultiplexer group 933 is located between the optical fiber collimator group and the turning prism 935, and the optical fiber collimator group is used for collimating the received two optical signals. The demultiplexer group 933 divides the collimated two-way optical signal into an eight-way optical signal, the collimated eight-way optical signal is reflected by a turning prism 935, the fourth lens group 936 gathers the collimated eight-way optical signal, and the optical receiving chip group 937 converts the received eight-way optical signal into an electrical signal.

In some examples of the embodiment of the present disclosure, the optical receiver 903 may also be provided without a fourth lens group 936, that is, the eight-way optical signal after being turned by the turning prism 935 exits from the exit surface of the turning prism 935 and is received by the optical receiving chip group 937, and the optical receiving chip group 937 converts the received eight-channel optical signal into an electrical signal.

In some embodiments, a fiber collimator group comprises a plurality of fiber collimators. For example, a fiber collimator set consists of two fiber collimators set up side by side, one of which collimates the received 400G optical signal. Two fiber collimators collimate the received 400G optical signal respectively.

In some embodiments of the present disclosure, the optical fiber collimator is an integrated optical fiber collimator.

In other embodiments of the present disclosure, the optical fiber collimator is a combined optical fiber collimator formed by the combination of a fiber array and a collimating lens.

In other embodiments of the present disclosure, the optical fiber collimator is a combined optical fiber collimator formed by the combination of a fiber adapter and a collimating lens. An optical fiber adapter receives a 400G optical signal, and a collimating lens collimates the optical signal received by the optical fiber adapter to a 400G optical signal.

Since the fiber collimator can be a standard fiber collimator, or it can be a structural part formed by the combination of an optical fiber adapter and a collimating lens, then the fiber collimator group can be an integrated fiber collimator arranged in two parallel settings, or a combined fiber collimator arranged in parallel, or an integrated fiber collimator and a combined fiber collimator arranged in parallel.

As shown in FIG. 24 and FIG. 25, the optical fiber collimator group comprises a double optical fiber array 701 and a third lens group 932, the double optical fiber array 701 refers to two optical fibers arranged in parallel are installed on the substrate at specified intervals, and the third lens group 932 comprises two third lenses arranged in parallel, the third lens is a collapsing lens, and a collimating lens collimates the 400G optical signal to which an optical fiber transmits.

In some embodiments, the wave splitter group 933 comprises a plurality of wave splitters arranged in parallel. For example, the demultiplexer group 933 comprises two demultiplexers arranged in parallel, one splitting the collimated 400G optical signal into four 100G optical signals of different wavelengths.

The splitter can be either a Z-Block type splitter or an AWG (Array Waveguide Grating) type splitter. In the embodiment of the present disclosure, a Z-block type demultiplexer is used as a specific example in a specific example.

In some embodiments of the present disclosure, the bonding of a plurality of parallel demultiplexers can not only reduce the space occupied by the demultiplexer group 933 in the width direction of the transceiver body 901, so as to reduce the width size of the transceiver body 901; It is also possible to shorten the distance between all the outlets of the splitter group 933 and the central axis of the splitter group 933, thereby shortening the distance between the two outlets adjacent to the connection of the two splitters, wherein the width direction of the transceiver body 901 refers to the C-D direction in the transceiver body 901 (for example, refer to the direction shown in C-D in FIG. 11).

In some embodiments of the present disclosure, the incident surface of the splitter and the exit surface of the splitter are arranged parallel to each other so that the multiple optical signals after splitting the beam through the splitter are output at equal spacing in parallel.

In other embodiments of the present disclosure, the turning prism 935 comprises an incident surface, a turning surface and an exit surface, the incident surface of the turning prism 935 is oriented towards the demultiplexer group 933, the exit surface of the turning prism 935 is oriented towards the light receiving chip group 937, the turning surface of the turning prism 935 is located behind the incident surface of the turning prism 935 and is located above the exit surface of the turning prism 935, and the inclination angle of the turning surface of the turning prism 935 is a second preset angle, so that the light signal incident on the turning surface of the turning prism 935 can be emitted perpendicularly.

In some embodiments, the second preset angle is less than 45° to reduce the return of the optical signal along the original path. For example, the second preset angle is 39° ~43°, and in some examples, the second preset angle can be 39°, 40°, 41°, 42°, or 43°. It can be understood that in the embodiment of the present disclosure, the specific value of the second preset angle is only used as a specific example to illustrate, and does not limit the specific value of the second preset angle.

It should be noted here that the numerical values and numerical ranges involved in the embodiments of the present disclosure are approximate values, and there may be a certain range of errors due to the influence of the manufacturing process, and this part of the error can be considered negligible by those skilled in the art.

In some embodiments of the present disclosure, with reference to FIG. 24, the fourth lens group 936 comprises a plurality of focusing lenses arranged in parallel. For example, the fourth lens group 936 includes eight focusing lenses in parallel settings.

The upper surface of the circuit board 300 is provided with a DSP chip, a TIA (transimpedance amplifier chip) is integrated in the DSP chip, and the first electrical connection points in the DSP chip 302 are regularly arranged, then The two adjacent first electrical connection points of the DSP chip 302 are equally spaced. In order to ensure the high-frequency performance of the optical module, the first electrical connection point of the DSP chip 302 and the first pad of the optical receiving chip group 937 are required to have the shortest distance between the wiring distance. That is, the first pad spacing of the two adjacent optical receiving chips of the optical receiving chip group 937 is required to be equal and the second fixed value. However, since the first pad spacing of two adjacent optical receiving chips in the optical receiving chip group 937 can only achieve the first fixed value temporarily, the first pad spacing of the adjacent optical receiving chips in the optical receiving chip group 937 is required to be the first fixed value. The spacing between the two adjacent optical outlets of a single demultiplexer is equal, and the spacing of the first pad of the two adjacent optical receiver chips is equal. However, when the two demultiplexers form a demultiplexer group, the spacing between the two adjacent optical outlets between the two demultiplexers (in some examples, called the second spacing) is greater than the spacing of the two adjacent optical outlets of a single demultiplexer (in some examples, it is called the first spacing), so that the spacing of the optical path emitted by the two adjacent optical outlets between the two adjacent demultiplexers is greater than the spacing of the optical path emitted by the two adjacent optical outlets of a single slotter. That is, the spacing of the optical path emitted by the two adjacent optical outlets between the two adjacent demultiplexers is greater than the first pad spacing of the two adjacent optical receiving chips of the optical receiving chip group. In order to solve this problem, in some embodiments, the spacing of the optical path emitted by two adjacent optical outlets between two adjacent demultiplexers can be shortened by adjusting the splitter. However, this requires a new wave splitter to be re-customized, which greatly increases the production cost.

In order to solve this problem, in some embodiments, the optical path spacing before the input of the turning prism is shortened by an optical path offset sheet group 934 through an optical path offset sheet group 934. For example, the optical path spacing before the input of the turning prism is shortened by the optical path offset sheet group 934 through the optical path offset sheet group 934, so that the spacing of the adjacent two optical paths in all the optical paths after the offset is equal and is the first fixed value. That is: an optical path offset sheet group 934 is arranged behind the demultiplexer group 933, the optical path offset sheet group 934 is located between the demultiplexer group 933 and the turning prism 935, and the optical path is offset after being refracted by the optical path offset sheet group 934, The spacing of the adjacent two optical paths in all the offset optical paths is equal, similar or approximate, and the offset multi-channel optical signal is reflected by the turning prism 935 and emits perpendicularly.

In some embodiments, the central axis of the optical path offset sheet group 934 coincides with the central axis of the demultiplexer group 933, so that all optical paths after passing through the beam splitting of the demultiplexer group 933 can be received by the optical path offset sheet group 934, and all of them are offset by the optical path offset sheet group 934, thereby improving the coupling efficiency.

In some embodiments of the present disclosure, the optical path offset sheet group 934 comprises at least one optical path offset sheet. For example, the optical offset sheet 934 comprises an optical offset sheet that offsets eight 100G optical signals of different wavelengths to the central axis of the optical offset sheet group 934.

In other embodiments of the present disclosure, the optical path offset sheet group 934 comprises at least two optical path offset plates arranged in parallel, an optical path offset sheet is arranged corresponding to a demultiplexer, and an optical path offset sheet offsets four 100G optical signals of different wavelengths in the direction of the central axis of the optical path offset sheet group 934. In some examples, the optical offset plate group 934 consists of two optical offset plates set in parallel, one of which corresponds to a splitter.

In some embodiments, the incident surface of the optical path offset sheet is parallel or approximately parallel to the exit surface of the optical splitter, so that the optical signals incident to the optical path offset are equally spaced and parallel to each other, so as to avoid interference by two adjacent optical signals incident on the optical path offset sheet.

In other embodiments, the incident surface and the exit surface of the optical path offset sheet group 934 are parallel to each other, so that the optical signal incident to the incident surface of the optical path offset sheet group 934 and the optical signal to the emission surface of the optical path offset sheet group 934 are parallel to each other, and the optical path direction is not changed, and the distance between the optical path and the central axis of the optical path offset sheet group 934 is only reduced.

In some embodiments, the parallel arrangement of optical path offset pieces is bonded, not only can reduce the space occupied by the optical path offset sheet group 934 in the width direction of the transceiver body 901, so as to reduce the width size of the transceiver body 901; The distance between each optical signal after passing through the wavelength splitter group 933 and the central axis of the optical path offset sheet group 934 can also be shortened, and the spacing of two adjacent optical paths at the connection of the two optical path offset sheets can be shortened to match the optical receiving chip group 937.

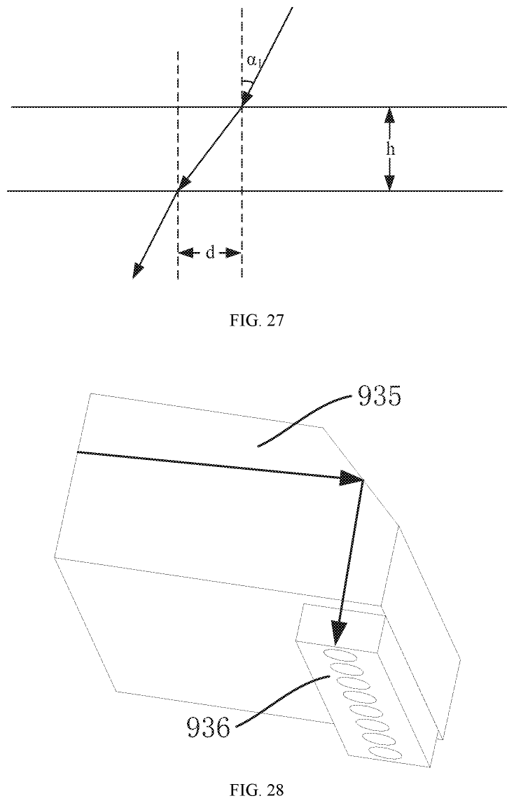

FIG. 27 is a schematic diagram of the optical path offset sheet in the optical module provided according to the embodiment of the present disclosure. As shown in FIG. 27, the optical path is offset after refraction by the optical path offset sheet, and the optical path offset d is in a preset relationship with the refractive index n2 of the optical path offset sheet, the thickness h of the optical path offset sheet and the incident angle α1 of the optical path, wherein

$$d = h * sin {α}_{1} [ 1 - \frac{cos {α}_{1}}{\sqrt{{( \frac{{n}_{2}}{{n}_{1}} )}^{2} - {sin}^{2} {α}_{1}}} ]$$

wherein d is the optical path offset, h is the thickness of the optical path offset sheet, α1 is the angle of incidence, and n2 is the refractive index of the optical path offset sheet, n1 is the refractive index of air.

In some embodiments of the present disclosure, an optical module comprises a circuit board and an optical transceiver component, and the optical transceiver component is connected with a circuit board. The circuit board is provided with an electrical chip and an optical receiving chip group, the electrical chip is connected with the optical receiving chip group, and the spacing of the two first electrical connection points adjacent to the electric chip is equal. In order to ensure the high-frequency performance of the optical module, the first pad spacing of the two adjacent optical receiving chips adjacent to the optical receiving chip group connected to the first electrical connection point of the electrical chip is required to be equal. The optical receiving component comprises an optical receiver, the optical receiver comprises a wave splitter set, a turning prism and an optical receiving chip group, the turning prism is positioned above the optical receiving chip group, and the optical receiving chip group comprises a plurality of optical receiving chips arranged in parallel, and the first pads of the two adjacent optical receiving chips are equally spaced. The demultiplexer group comprises at least two demultiplexers, the spacing of the two adjacent optical outlets of a single demultiplexer is equal to the first pad spacing of the two adjacent optical receiving chips, the spacing of the adjacent two optical outlets between the two adjacent demultiplexers is greater than the spacing of the adjacent two optical outlets of a single demultiplexer, that is, the spacing of the adjacent two optical outlets between the two adjacent optical splitters is greater than the first pad spacing of the two adjacent optical receiving chips, resulting in the multi-channel optical signal after the beam splitting by the demultiplexer group cannot be fully coupled to the corresponding optical receiving chip, Reduced coupling efficiency.

In order to avoid this problem, an optical path offset sheet group is set after the demultiplexer group, the optical path offset sheet group is located between the demultiplexer group and the transition prism, and the optical path offset sheet group is used to shorten the optical path between the adjacent two optical splitters before the input transition prism after the two adjacent light outlets are ejected, so that the spacing of the adjacent two optical paths in all the optical paths after the offset is equal to the first pad spacing of the two adjacent optical receiving chips of the optical receiving chip group, In addition, the offset optical path is reflected by the turning prism and coupled to the corresponding optical receiving chip as much as possible to improve the coupling efficiency. Among them, the two adjacent optical outlets between the two adjacent demultiplexers refer to the first optical outlet closest to the second demultiplexer of the first demultiplexer of the two adjacent demultiplexers and the optical outlet closest to the first demultiplexer of the second demultiplexer of the two adjacent demultiplexers.

In some embodiments, the optical path spacing between the adjacent two optical outlets between the adjacent two optical splitters is shortened by the optical path offset piece group before the input transition prism after ejection, so that the spacing of the two adjacent optical paths after the offset is equal to the first pad spacing of the two adjacent optical receiving chips of the optical receiving chip group, thereby improving the coupling efficiency.

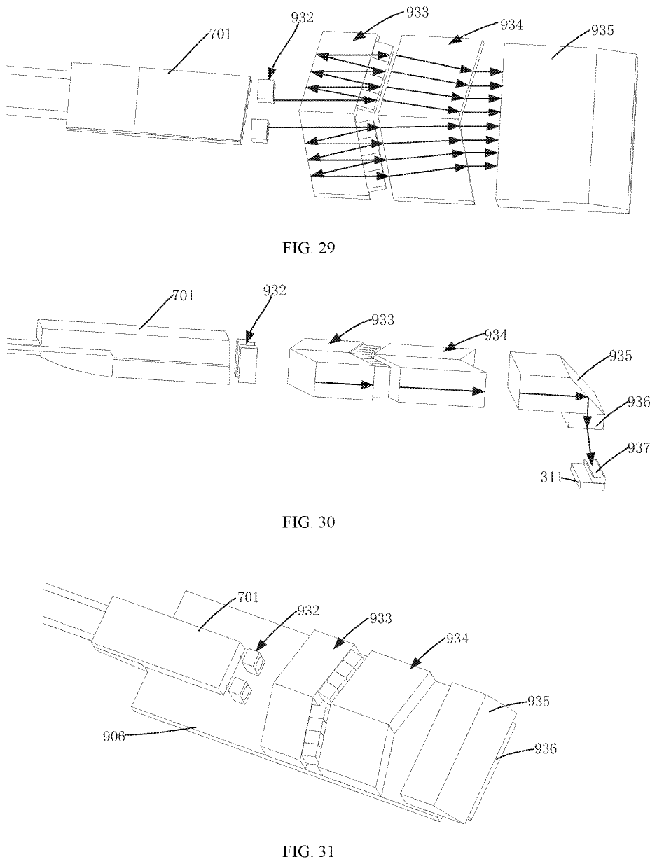

FIG. 28 is an assembly drawing of the turning prism and the fourth lens group in the optical module provided according to the embodiments of the present disclosure, FIG. 29 is an optical path diagram of the optical receiver in the optical module provided according to the embodiments of the present disclosure, and FIG. 30 is an optical path diagram of the optical receiver in the optical module provided according to the embodiment of the present disclosure at another viewing angle. As shown in FIG. 28-FIG. 30, in some embodiments of the present disclosure, the fourth lens group 936 is located between the turning prism 935 and the optical path offset sheet group 934, and the fourth lens group 936 converges the offset optical signals on the turning prism 935. the fourth lens group 936 may be mounted on one side of the transition prism 935 toward the optical path offset sheet group 934; It may also be placed on the receiving slot 913 without contact with the turning prism 935.

In some embodiments of the present disclosure, the fourth lens group 936 is located between the turning prism 935 and the optical receiving chip group 937, and the fourth lens group 936 converges the reflected optical signals to the optical receiving chip group 937 so as to realize the reception of the optical signal. The fourth lens set 936 can be mounted on the side of the transition prism 935 facing the light receiving chip group 937; It can also be placed on the circuit board 300 by means of a support bracket and not in contact with the turning prism 935.

In the embodiment of the present disclosure, as shown in FIG. 28, the fourth lens group 936 is mounted on one side of the turning prism 935 facing the optical receiving chip group 937, and the collimated light is converged after reflection, so that the optical path loss is reduced and the coupling efficiency is improved. In addition, the fourth lens set 936 is mounted on the side of the turning prism 935 facing the optical receiving chip group 937, which shortens the distance between the turning prism 935 and the optical receiving chip group 937, thereby reducing the height size of the transceiver body 901.

In order to improve the coupling efficiency, as shown in FIG. 8 and FIG. 26, in some embodiments, the upper surface of the circuit board 300 is provided with a shelf 301, a shelf substrate 311 is arranged in the shelf 301, an optical receiving chip group 937 is placed on the placing substrate 311, and the vertical distance between the fourth lens group 936 and the optical receiving chip group 937 is the focal length of the fourth lens group 936, so that the light spots converged by the fourth lens group 936 fall exactly on the optical receiving chip group 937, so that the coupling efficiency is improved.

It can be understood that in some examples, the optical receiving chip group 937 can also be arranged on the surface of the circuit board 300, and correspondingly, the fourth lens group 936 is supported to one side facing the circuit board 300 by arranging spacers or supports, so that the vertical distance between the fourth lens group 936 and the receiving chip group 937 is the focal length of the fourth lens group 936.

In other examples, a slot 301 may also be arranged on the upper surface of the circuit board, and the optical receiving chip group 937 is arranged in the slot 301, that is, the shelf 311 is not arranged in the slot 301, and the fourth lens group 936 is supported to one side facing the circuit board 300 by arranging a spacer or a support, so that the vertical distance between the fourth lens group 936 and the receiving chip group 937 is the focal length of the fourth lens group 936.

The DSP chip 302 is connected with the pad on the circuit board 300 through a second solder ball, and the optical receiving chip group 937 is placed on the substrate 311, so that the wiring distance between the first solder ball of the DSP chip 302 and the optical receiving chip is shortened, the loss of high-frequency signal is reduced, and the high-frequency performance of the optical module is improved.

As shown in FIG. 29 and FIG. 30, in some embodiments, the 800G optical signal is collimated through the third lens group 932, the collimated 800G optical signal is divided into eight channels of 100G optical signal through the demultiplexer group 933, the eight-channel 100G optical signal is offset by the optical path offset sheet group 934, the offset eight-channel 100G optical signal is reflected by the turning prism 935, and the reflected eight-channel 100G optical signal is converged into the optical receiving chip group 937 through the fourth lens group 936, The optical receiver chip group 937 converts eight 100G optical signals into eight 100G electrical signals.

FIG. 31 is an assembly drawing of an optical receiver and a receiving substrate in an optical module provided according to the embodiments of the present disclosure. As shown in FIGS. 26 and 31, in some embodiments, the central axes of the double-fiber array 701, the third lens group 932 and the demultiplexer group 933 coincide, the double-fiber array 701, the third lens group 932, the demultiplexer group 933, the optical path offset sheet group 934 and the turning prism 935 are all fixed on the receiving substrate 906, and the receiving substrate 906 is fixed in the receiving groove 913 and extends out of the end of the receiving groove 913.

In some embodiments, the central axes of the double-fiber array 701, the third lens group 932 and the demultiplexer group 933 coincide, and the double-fiber array 701, the third lens group 932 and the demultiplexer group 933 are directly fixed in the receiving slot 913.

In order to improve the coupling efficiency of the double-fiber array 701, the third lens group 932 and the demultiplexer group 933, in some embodiments of the present disclosure, a plurality of support bosses with elevated heights are arranged at the positions of the receiving grooves 913 corresponding to the double-fiber array 701, the third lens group 932 and the demultiplexer group 933, so that the central axis of the double-fiber array 701, the third lens group 932 and the optical inlet of the demultiplexer group 933 coincide, so as to improve the coupling efficiency.

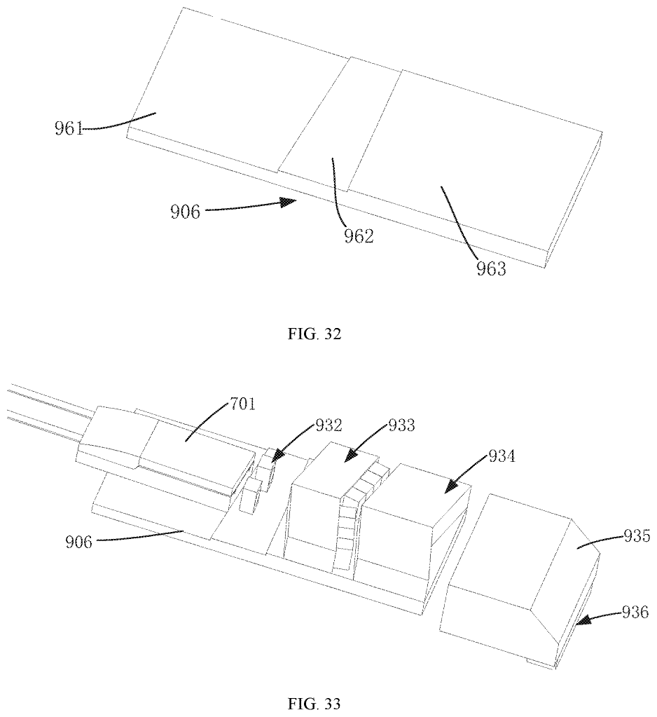

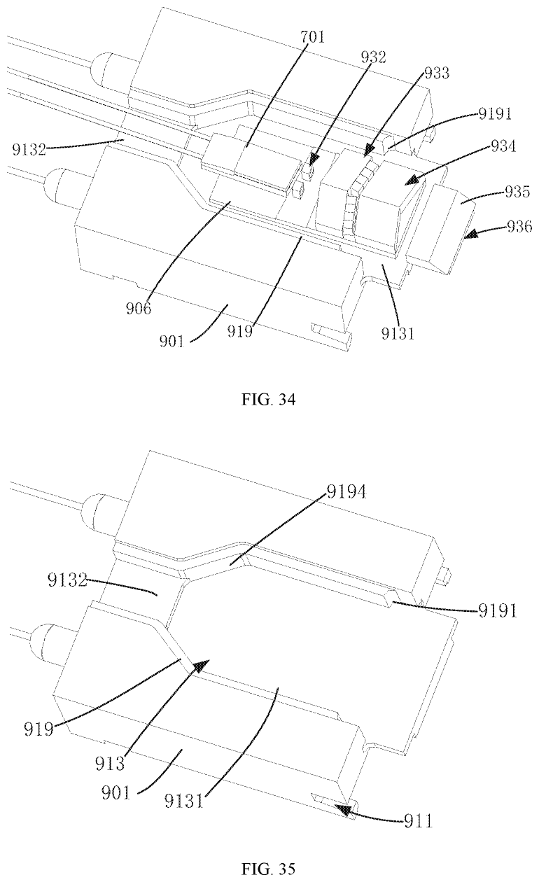

FIG. 32 is another structural drawing of the receiving substrate in the optical module provided according to the embodiment of the present disclosure, and FIG. 33 is another assembly drawing of the optical receiver and the receiving substrate in the optical module provided according to the embodiment of the present disclosure, and FIG. 34 is based on An assembly drawing of an optical receiver and a transceiver tube in an optical module provided in the embodiment of the present disclosure. As shown in FIG. 32-FIG. 34, in some embodiments of the present disclosure, a receiving substrate 906 is arranged on the receiving groove 913, a double optical fiber array 701, a third lens group 932, a demultiplexer group 933 and an optical path offset sheet group 934 are arranged on the receiving substrate 906, the turning prism 935 is arranged in the receiving groove 913, and the receiving substrate 906 is provided with a supporting surface that is raised sequentially along the propagation direction of the receiving optical path, so that the central axis of the double optical fiber array 701, The central axis of the third lens group 932 coincides with the central axis of the optical inlet of the demultiplexer group 933, thereby improving the coupling efficiency.

For example, the upper surface of the receiving substrate 906 is provided with a first supporting surface 961, a second supporting surface 962 and a third supporting surface 963 along the propagation direction of the receiving optical path, the heights of the first supporting surface 961, the second supporting surface 962 and the third supporting surface 963 are raised sequentially, a double optical fiber array 701 is placed on the first supporting surface 961, a third lens group 932 is placed on the second supporting surface 962, a demultiplexer group 933 and an optical path offset sheet group 934 are placed on the third supporting surface 963, In order to make the central axis of the double optical fiber array 701, the central axis of the third lens group 932 and the central axis of the optical inlet of the demultiplexer group 933 coincide, so as to improve the coupling efficiency.

As shown in FIG. 34, in some embodiments, the receiving groove 913 comprises a first receiving groove portion 9131 and a second receiving groove portion 9132, the receiving substrate 906 is placed on the first receiving groove portion 9131, the double optical fiber array 701, the third lens group 932, the demultiplexer group 933 and the optical path offset sheet group 934 are placed on the receiving substrate 906, and the end of the first receiving groove portion 9131 extends beyond the side wall end of the transceiver body 901 the turning prism 935 is not placed on the receiving substrate 906, the turning prism 935 is placed on the end of the first receiving groove 9131 of the receiving groove 913, the optical fiber connected with the double optical fiber array 701 is placed on the second receiving groove portion 9132, the height of the second receiving groove portion 9132 is higher than that of the first receiving groove portion 9131, that is, the depth of the depression of the second receiving groove portion 9132 from the transceiver body 901 is less than the depression depth of the first receiving groove portion 9131, so that the central axis of the optical fiber connected to the dual-fiber array 701 coincides with the central axis of the dual-fiber array 701 to avoid damage to the optical fiber connected to the dual-fiber array 701. Wherein, the end of the first receiving groove 9131 refers to the end of the first receiving groove 9131 away from the second receiving groove 9132, and the end of the side wall of the transceiver body 901 refers to the end of the side wall of the transceiver body 901 away from the second receiving groove 9132.

In some examples, the turning prism 935 may also be placed at one end of the receiving substrate 906 facing the circuit board 300, and the receiving substrate 906 facing the circuit board 300 may extend beyond the first receiving slot 9131. It is understood that the receiving substrate 906 can be placed on a lower surface than on which the dual-optical offset panel 934 is placed.

As shown in FIG. 32, in some embodiments, the upper surface of the transceiver pipe body 901 is provided with a third engaging surface 919, the third engaging surface 919 is formed by the side wall of the transceiver pipe body 901 inwardly concave, and the third engaging surface 919 is enclosed with the side wall of the transceiver pipe body 901 to form a third limiting notch. For example, the third clamp junction 919 and the side wall extending from the third clamping junction 919 in the transceiver body 901 form a third limiting gap.

As shown in FIG. 32, in some embodiments, one end of the transceiver body 901 close to the circuit board 300 is provided with a fourth card junction 9191, the fourth snap junction 9191 is oriented towards the circuit board 300, and the fourth clamp junction 9191 is enclosed with the bottom surface of the receiving groove 913 and the side wall of the transceiver body 901 to form a fourth limiting gap. For example, the fourth clamp junction 9191 is enclosed with the bottom surface of the receiving groove 913 and the side wall extending from the bottom surface of the receiving groove 913 in the transceiver pipe body 901 to form a fourth limiting notch.

In some embodiments, a limiting surface is arranged on the side wall of the transceiver body 901, and the limiting surface is used for limiting the position of the receiving substrate 906.

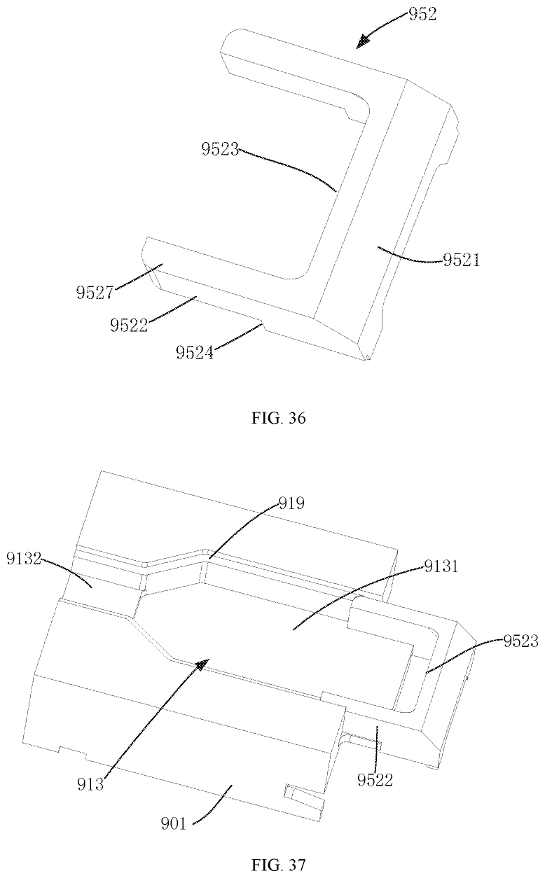

FIG. 35 is a structural diagram of the transceiver body in an optical module provided according to the embodiments of the present disclosure from another perspective, FIG. 36 is a structural diagram of the second receiving cover plate of an optical module provided according to the embodiments of the present disclosure, and FIG. 37 is an assembly drawing of the transceiver body and the second receiving cover plate in the optical module provided according to the embodiments of the present disclosure. As shown in FIG. 35-FIG. 37, the side wall of the transceiver body 901 has a third limiting surface 9194, the third limiting surface 9194 is located between two parallel planes of the side wall of the transceiver body 901, the receiving substrate 906 is connected with the third limiting surface 9194, the third limiting surface 9194 is a bending surface, and the two third limiting surfaces 9194 are symmetrically arranged along the transmitting and receiving tube body 901, The two third limiting surfaces 9194 gradually reduce the distance between the side walls of the transceiver body 901 from being close to the circuit board 300 to being far away from the circuit board 300 along the length direction of the transceiver body 901, so as to limit the position of the receiving substrate 906 in the receiving groove 913, so as to facilitate the placement of the receiving substrate 906.

As shown in FIG. 36 and FIG. 37, in order to facilitate the installation of the receiving cover plate 905, in some embodiments of the present disclosure, the receiving cover plate 905 comprises a first receiving cover plate 951 and a second receiving cover plate 952 (as shown in FIG. 24 with reference), the cover of the first end of the first receiving cover plate 951 is sealed on the third engaging surface 919, and the side wall of the first receiving cover plate 951 is clamped on the inner surface of the side wall of the transceiver pipe body 901, so that the first receiving cover plate 951 is clamped into the third limiting notch; the cover of the second end of the first receiving cover plate 951 is sealed on the first end of the second receiving cover plate 952 so that the first receiving cover plate 951 is hermetically connected with the second receiving cover plate 952; the cover of the first end of the second receiving cover plate 952 is sealed on the bottom surface of the receiving groove 913, the end face of the first end of the second receiving cover plate 952 is clamped on the fourth engaging surface 9191, and the side of the second receiving cover plate 952 is clamped on the side wall of the transceiver pipe body 901, so that the second receiving cover plate 952 is clamped into the fourth limiting notch; The lower surface of the second end of the second receiving cover plate 952 is clamped onto the circuit board 300 so that the second receiving cover plate 952 is connected with the circuit board 300.

The second end of the second receiving cover plate 952 is not located at the end of the side wall of the transceiver body 901, but extends out of the end of the side wall of the transceiver body 901, so that the optical receiver 903 is placed in the receiving cavity composed of the receiving cover plate 905, the transceiver body 901 and the circuit board 300.

In order to make the first receiving cover plate 951 hermetically connected with the transceiver body 901, in some embodiments, the shape of the first receiving cover plate 951 matches the shape of the third clamping face 919. For example, the shape of the first receiving cover 951 is the same or similar to that of the third clamping face 919.

In some embodiments, one end of the second receiving cover plate 952 is clamped into the receiving groove 913 of the transceiver body 901, and the other end of the second receiving cover plate 952 is clamped on the circuit board 300 so that the second receiving cover plate 952 is hermetically connected with the transceiver body 901 and the circuit board 300.

In order to facilitate the second receiving cover plate 952 to be fixed on the receiving groove 913 and the circuit board 300, in some embodiments, the second receiving cover plate 952 is bent, one end of the second receiving cover plate 952 is parallel to the circuit board 300, and the other end of the second receiving cover plate 952 is perpendicular to the circuit board 300. The second receiving cover plate 952 is bent so that the first end of the second receiving cover plate 952 is fixed on the receiving groove 913, and the second end of the second receiving cover plate 952 is fixed on the circuit board 300.

In order to make the second receiving cover plate 952 hermetically connected with the transceiver body 901 and the circuit board 300, in some embodiments, a engaging notch 9524 is arranged on the lower surface of the second receiving cover plate 952 (with reference to FIG. 36). One side side of the engaging notch 9524 is connected with the end face of the receiving groove 913 in contact so that the second receiving cover plate 952 is clamped on the receiving groove 913 of the transceiver body 901, and the second receiving cover plate 952 is hermetically connected with the transceiver pipe body 901 and the circuit board 300.

In some embodiments, the two sides of the enclosing engaging notch 9524 are respectively in contact contact with the end face of the receiving groove 913 and the bottom surface of the receiving groove 913, so that the second receiving cover plate 952 is clamped on the receiving groove 913 of the transceiver body 901, and the second receiving cover plate 952 is hermetically connected with the transceiver pipe body 901 and the circuit board 300.

In order to realize the sealed connection between the first receiving cover plate 951 and the second receiving cover plate 952, in some embodiments, the upper surface of the second receiving cover plate 952 is provided with a fourth supporting surface 9527, and the fourth supporting surface 9527 is arranged in parallel with the first receiving cover plate 951. The second end of the first receiving cover plate 951 is placed on the fourth supporting surface 9527 so as to realize the sealed connection between the first receiving cover plate 951 and the second receiving cover plate 952.

In some embodiments, the second receiving cover plate 952 comprises a supporting arm 9521 and a clamping arm 9522, the clamping arm 9522 is close to the first receiving cover plate 951, the supporting arm 9521 is far away from the first receiving cover plate 951, the clamping arm 9522 has a engaging notch 9524, and the thickness of the clamping arm 9522 is smaller than the thickness of the supporting arm 9521, so that the clamping arm 9522 is clamped on the receiving groove 913, and the supporting arm 9521 is fixed on the circuit board 300.

In order to reserve a sufficient safety distance for the turning prism 935, in some embodiments of the present disclosure, the second receiving cover plate 952 is provided with a first avoidance notch 9523, and the first avoidance notch 9523 exposes the top surface of the turning prism 935 so that a sufficient safety distance is left between the top surface of the turning prism 935 and the first receiving cover plate 951.

In some optional examples, the first avoidance notch 9523 can be a half-pore structure shown in FIG. 36. It can be understood that in some examples, a groove or a through hole (such as a full hole) can also be arranged at the position corresponding to the turning prism 935 on the second receiving cover plate 952, so that the turning prism 925 can be avoided.

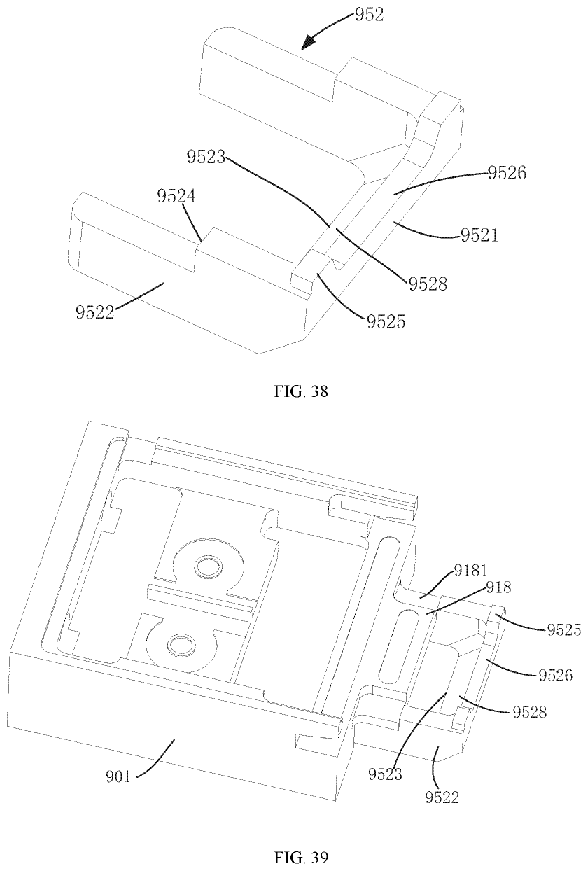

In other embodiments of the present disclosure, the second receiving cover plate 952 is provided with a second avoidance groove 9528 (with reference to FIG. 38). the second avoidance groove 9528 is located at the bottom of the first avoidance notch 9523, the turning face of the second avoidance groove 9528 and the turning prism 935 is correspondingly arranged, and the minimum vertical distance between the second avoidance groove 9528 and the turning prism 935 is greater than the preset distance, so as to avoid the turning surface of the turning prism 935, and then avoid the wearing of the turning prism 935.

For example, the turning surfaces of the second avoidance groove 9528 and the turning prism 935 have the same and approximate inclination angles, that is, the turning surfaces of the second avoidance groove 9528 and the turning prism 935 can be parallel or approximately parallel, and the vertical distance between the turning surfaces of the second avoidance groove 9528 and the turning prism 935 is greater than the preset distance, so as to avoid the turning prism 935 and thus avoid the wear of the turning prism 935. In some examples, the preset distance can be designed according to actual production needs, for example, it can be designed according to the volume and size requirements of the optical module provided in the embodiment of the present disclosure; In some examples, the preset distance may be 0.5 mm, 1.0 mm, or 1.5 mm, etc., and it can be understood that the specific value of the preset distance in the embodiment of the present disclosure is only used as a distance description, and is not a specific restriction on the preset distance.

The second receiving cover plate 952 comprises a supporting arm 9521 and two clamping arms 9522, the two clamping arms 9522 are respectively connected with the two ends of the supporting arm 9521 so that the top view of the second receiving cover plate 952 is U-shaped, the two clamping arms 9522 and the supporting arm 9521 enclose the first avoidance opening 9523, and the lower surface of the supporting arm 9521 is concave inward to form a second avoidance groove 9528.

As shown in FIG. 37, the bottom surface of the clamping arm 9522 is in contact with the bottom surface of the first receiving groove portion 9131, one side wall of the clamping arm 9522 is in contact with one side of the fourth limiting notch, and the end face of the clamping arm 9522 is in contact with the fourth engaging surface 9191, so as to realize the sealed connection between the clamping arm 9522 and the fourth limiting notch.

FIG. 38 is a structural diagram of the second receiving cover in an optical module provided according to the embodiment of the present disclosure at another viewing angle, and FIG. 39 is an assembly drawing of the transceiver body and the second receiving cover in an optical module provided according to the embodiment of the present disclosure at another viewing angle. As shown in FIG. 38 and FIG. 39, in some embodiments, the lower surface of the second end of the second receiving cover plate 952 is provided with a second avoidance notch 9526 and a second support boss 9525, the second avoidance notch 9526 is located between the two second support bosses 9525, the second support boss 9525 is in contact with the upper surface of the circuit board 300, and there is a gap between the second avoidance notch 9526 and the upper surface of the circuit board 300, The second avoidance notch 9526 is used to avoidance of electronic components on the circuit board 300. That is, the vertical distance between the second avoidance notch 9526 and the upper surface of the circuit board 300 is greater than the vertical distance between the second support boss 9525 and the upper surface of the circuit board 300, so that the second avoidance notch 9526 avoids the electronic components on the circuit board 300.

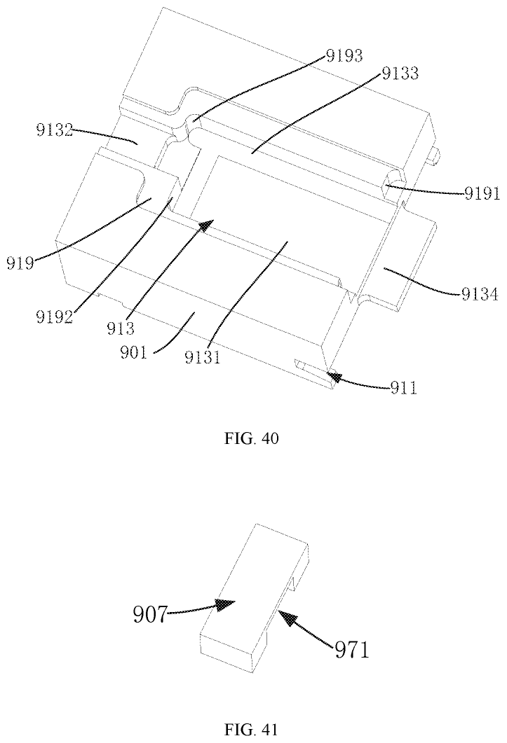

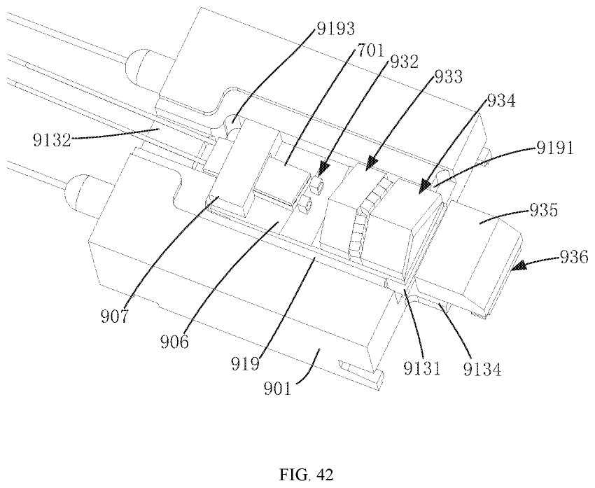

FIG. 40 is a structural diagram of the transceiver body in the optical module provided according to the embodiment of the present disclosure from another perspective, FIG. 41 is a structural diagram of the fixing parts in the optical module provided according to the embodiments of the present disclosure, and FIG. 42 is another assembly drawing of the optical receiver and the transceiver body in the optical module provided according to the embodiment of the present disclosure. As shown in FIG. 40-42, in some embodiments of the present disclosure, the receiving groove 913 of the transceiver pipe body 901 comprises a first receiving slot portion 9131, a second receiving slot portion 9132 and a third receiving slot portion 9134, the third receiving slot portion 9134, the first receiving slot portion 9131 and the second receiving slot portion 9132 are sequentially arranged along the length direction of the transceiver pipe body 901, and the second receiving slot portion 9132 is placed with a fiber optic connected with the double optical fiber array 701, the receiving substrate 906 is placed in the first receiving groove 9131, a turning prism 935 is not placed on the receiving substrate 906, a turning prism 935 is placed in the third receiving groove 9134, and the heights of the third receiving groove 9134, the first receiving groove 9131 and the second receiving groove 9132 are raised sequentially, so that the central axis of the optical fiber connected to the double optical fiber array 701 coincides with the central axis of the double optical fiber array 701 and avoids damage to the optical fiber connected with the double optical fiber array 701; The emission surface of the optical path offset sheet group 934 can also be located on the projection of the turning prism 935, that is to say, the light emitted from the exit surface of the optical path offset sheet group 934 is all projected on the turning prism 935, and the photosensitive surface of the optical receiving chip group 937 is located in the projection area of the turning plane 9351 of the turning prism 935, so that the optical signals after the optical path offset sheet group 934 are all reflected by the turning prism 935 and are all received by the optical receiving chip group 937, so that the coupling efficiency can be improved.

In some examples, the receiving groove 913 may only comprise a first receiving groove portion 9131 and a second receiving groove portion 9132, and when the end of the first receiving groove portion 9131 extends beyond the end of the side wall of the transceiver body 901, the end of the first receiving groove portion 9131 and the supporting piece 918 may be a structural member; It can also be two structural members.

In other examples, the receiving groove 913 may also comprise a first receiving groove portion 9131, a second receiving groove portion 9132 and a third receiving groove portion 9134, and the third receiving groove portion 9134 and a supporting piece 918 may be a structural member; It can also be two structural members.

In order to avoid glue overflowing above the receiving substrate 906, in some embodiments, a glue overflow groove 9133 is arranged in the first receiving groove portion 9131, the glue overflow groove 9133 is located at the edge of the first receiving groove portion 9131, and the height of the glue overflow groove 9133 is lower than the height of the first receiving groove portion 9131, so that the glue after bonding enters the glue overflow groove 9133 and the glue is prevented from overflowing above the receiving substrate 906.

In order to realize the limiting fixation of the receiving substrate 906, in some embodiments, the transceiver body 901 is provided with a first limiting surface 9192 and a second limiting surface 9193, the first limiting surface 9192 and the second limiting surface 9193 are both oriented towards the circuit board 300, the first limiting surface 9192 is located on one side wall of the transceiver body 901, the second limiting surface 9193 is located on the other side wall of the transceiver body 901, and the first limiting surface 9192 is closer to the circuit board 300 relative to the second limiting surface 9193, the receiving substrate 906 is positioned at the first limiting surface 9192 so as to facilitate the limitation of the position of the receiving substrate 906 in the receiving groove 913; The glue overflow groove 9133 is located at the second limiting surface 9193 to increase the area of the glue overflow groove 9133, increase the capacity of the glue overflow groove 9133 to accommodate glue, and further avoid the glue overflowing above the receiving substrate 906.

In order to further limit the position of the receiving substrate 906 in the receiving groove 913, in some embodiments, the width dimensions of the first receiving groove 913 are matched with the width dimensions of the receiving substrate 906. For example, the width dimension of the first receiving groove 913 is greater than or equal to the width dimension of the receiving substrate 906. Exemplary, the width dimension of the first receiving groove 913 is equal to the width dimension of the receiving substrate 906.

In order to fix the double optical fiber array 701, as shown in FIG. 41 and FIG. 42, in some embodiments, a fixing piece 907 is arranged above the double optical fiber array 701, and the fixing piece 907 is located at the first limiting surface 9192. The fixing piece 907 is provided with a fixing groove 971, and the fixing groove 971 is clamped above the double optical fiber array 701 to realize the fixing of the double optical fiber array 701.

In some embodiments, the upper surface of the optical path offset sheet group 934 is lower than the top of the turning surface 9351 of the turning prism 935, and the lower surface of the optical path offset sheet group 934 is higher than the bottom end of the turning surface 9351 of the turning prism 935, that is, the exit surface of the optical path offset sheet group 934 is located between the bottom end of the turning plane 9351 of the turning prism 935 and the top of the turning surface 9351 of the turning prism 935, so that the optical path emitted by the optical path offset sheet group 934 enters the turning prism 935, and the reflection is realized by the turning prism 935; The light-sensitive planes of the light-receiving chip group 937 are all located directly below the turning surface 9351 of the turning prism 935, that is, the light-sensitive surface of the light-receiving chip group 937 is located between the projection area at the top of the turning surface 9351 of the turning prism 935 and the projection area at the low end of the turning surface 9351, so that all the optical signals that converge the light after being reflected by the turning prism 935 are received by the light-sensitive surface of the light-receiving chip group 937. Therefore, the turning prism 935 can be fixed on the receiving substrate 906, as shown in FIG. 31; The turning prism 935 can also be fixed on the end of the first receiving groove 9131 of the receiving groove 913, as shown in FIG. 34; The turning prism 935 can also be fixed on the third receiving groove portion 9134 of the receiving groove 913, as shown in FIG. 42.

Finally, it should be noted that the above embodiments are only used to illustrate the technical solutions of the present disclosure, and not to limit them; Although the disclosure is described in detail with reference to the foregoing embodiments, a person skilled in the art should understand that it may still modify the technical solutions described in the foregoing embodiments, or replace some of the technical features therein; These modifications or substitutions do not depart from the essence of the corresponding technical solutions from the spirit and scope of the technical solutions of the embodiments of the present disclosure.

What is claimed is:

1. An optical module, comprising:
a circuit board, which is provided thereon with an optical receiving chip group;
an optical transceiver part comprising a transceiver body, a first end of the transceiver body being provided with a first notch, and one end of the circuit board is inserted in the first notch;
an upper surface of the transceiver body is provided with a receiving groove, the receiving groove comprising a first receiving groove portion and a second receiving groove portion, wherein a receiving substrate and an optical receiver are arranged in the first receiving groove portion, and the receiving substrate extends beyond the first end of the transceiver body; the second receiving groove portion is configured for arranging optical fibers;
the optical receiver comprises an optical fiber collimator group, a demultiplexer group, an optical path offset piece group and a turning prism, wherein the optical fiber collimator group is coupled with the optical fibers; the optical fiber collimator group, the demultiplexer group and the optical path offset piece group are arranged on the receiving substrate, and the optical path offset piece group is located between the demultiplexer group and the turning prism; the turning prism is positioned above the light receiving chip group; optical signals transmitted from the optical fibers are collimated by the optical fiber collimator, and collimated optical signals are demultiplexed by the demultiplexer group, the optical signals after being demultiplexed are then offset by the optical path offset piece group, which are then reflected by the turning prism to be converged to the optical receiving chip group; central axes of the optical fiber collimator, the demultiplexer group and the optical path offset sheet group are coaxial; the demultiplexer group comprises at least two demultiplexers, each demultiplexer having a plurality of optical outlets, and the at least two demultiplexers are arranged side by side in close contact to reduce a distance between all optical outlets of the demultiplexer group and central axis of the demultiplexer group; and the optical path offset sheet group is configured to reduce a spacing between optical paths exiting from two adjacent optical outlets of two adjacent demultiplexers prior to entering the turning prism.

2. The optical module of claim 1, wherein the optical paths are offset after being refracted by the optical path offset sheet group, and a spacing between two adjacent optical paths in the offset optical paths is equal to a pitch of first pads of two adjacent optical receiving chips; and an amount of offset of the optical paths has a predetermined relationship with a refractive index of the optical path offset sheet group, a thickness of the optical path offset sheet group and an incident angle of the optical paths.

3. The optical module of claim 1, wherein the optical receiver further comprises a fourth lens group; the demultiplexer group is positioned between the optical fiber collimator group and the optical path offset piece group; the fourth lens group is fixedly connected with one side of the turning prism facing the optical receiving chip group; a placing groove is arranged on the circuit board, a placing substrate is arranged in the placing groove, and the optical receiving chip group is arranged on the placing substrate.

4. The optical module of claim 3, wherein the optical fiber collimator group comprises a double optical fiber array and a third lens group;
the receiving substrate is provided with a first supporting surface, a second supporting surface and a third supporting surface;
the double optical fiber array is arranged on the first supporting surface, the third lens group is arranged on the second supporting surface, the demultiplexer group and the optical path offset sheet group are arranged on the third supporting surface, heights of the first supporting surface, the second supporting surface and the third supporting surface are raised sequentially, wherein the third lens group is located between the double optical fiber array and the demultiplexer group.

5. The optical module of claim 1, wherein an end of the first receiving groove extends beyond an end of side wall of the transceiver body, and the end of the first receiving groove is configured to arrange the turning prism.

6. The optical module of claim 1, wherein an end of the first receiving groove extends out of an end of side wall of the transceiver body to form a third receiving groove, the third receiving groove being located lower than the first receiving groove, and the third receiving groove being configured to arrange the turning prism.

7. The optical module of claim 1, wherein the upper surface of the transceiver body is disposed with a limiting surface, and the limiting surface is configured to limit a position of the receiving substrate;
the limiting surface comprises a first limiting surface and a second limiting surface, wherein the first limiting surface is located at one side wall of the transceiver body; the second limiting surface is located at the other side wall of the transceiver body; the first limiting surface and the second limiting surface face towards the circuit board, and the first limiting surface is closer to the circuit board than the second limiting surface; and the receiving substrate is stopped at the first limiting surface;
or, the limiting surface comprises two third limiting surfaces, each third limiting surface being located on one side wall of the transceiver body, and a distance between the two third limiting surfaces is gradually narrowed along a length direction of the transceiver body.

8. The optical module of claim 1, wherein
the optical transceiver part further comprises a receiving cover plate, and the receiving cover plate is configured to be covered on the upper surface of the transceiver body;
the upper surface of the transceiver body is disposed with a third engaging surface, the third engaging surface and side wall of the transceiver body form a third limiting notch; the first end of the transceiver body facing towards the end of the circuit board is disposed with a fourth engaging surface, and wherein, the fourth engaging surface and the side wall of the transceiver body and a bottom surface of the receiving groove form a fourth limiting notch; the receiving cover plate comprises a first receiving cover plate and a second receiving cover plate, wherein a first end of the first receiving cover plate is engaged at the third limiting notch, a second end of the first receiving cover plate is covered on a first end of the second receiving cover, the first end of the second receiving cover plate is engaged at the fourth limiting notch, and a second end of the second receiving cover plate is engaged on an upper surface of the circuit board.

9. The optical module of claim 8, wherein the first end of the second receiving cover plate is disposed with a first avoidance notch, and the first avoidance notch is configured to avoid the turning prism in the receiving groove; a bottom of the first avoidance notch is provided with a second avoidance groove, the second avoidance groove is correspondingly arranged with a turning face of the turning prism, and a vertical distance between the second avoidance groove and the turning surface of the turning prism is greater than a preset distance.

10. The optical module of claim 8, wherein a lower surface of the second receiving cover is disposed with an engaging notch, and one side of the engaging notch is in contact with an end face of the receiving groove.

11. The optical module of claim 10, wherein the other side of the engaging notch is in contact with bottom surface of the receiving groove.

12. The optical module of claim 8, wherein a lower surface of the second end of the second receiving cover plate is provided with a second support boss and a second avoidance notch, wherein the second supporting boss is in contact with the upper surface of the circuit board; there is a gap between the second avoidance notch and the upper surface of the circuit board; the second avoidance notch is located between two second support bosses; and the second avoidance notch is configured to avoid electronic components on the circuit board.

13. The optical module of claim 1, wherein a lower surface of the transceiver body is provided with an emission groove, and an optical emitter is arranged in the emission groove, wherein the optical emitter comprises a laser chip group, a first lens group, a multiplexer group and a second lens group; the emission groove comprises a first emitting groove, a second emitting groove and a third emitting groove, wherein the laser chip group and the first lens group are arranged in the first emitting groove; the multiplexer group is arranged in the second emitting groove; the second lens group is arranged in the third emitting groove; and heights of the second emitting groove, the third emitting groove and the first emitting groove are raised sequentially.

14. The optical module of claim 13, wherein the optical emitter further comprises an emitting optical fiber adapter group, the first lens group is located between the laser chip group and the multiplexer group, and the second lens group is located between the multiplexer group and the emitting optical fiber adapter group;
the laser chip group comprises a plurality of laser chips arranged in parallel, and the laser chips are configured to emit optical signals;
the first lens group comprises a plurality of collimating lenses arranged in parallel, and the collimating lenses are configured to collimate the optical signals;
the multiplexer group comprises a plurality of multiplexers arranged in parallel, and the multiplexers are configured to multiplex multiple paths of collimated lights into a beam of collimated light;
the second lens group comprises a plurality of focusing lenses arranged in parallel, and the focusing lenses are configured to converge the collimated light;
the emitting optical fiber adapter group is correspondingly arranged with the second lens group, and comprises two emitting optical fiber adapters arranged in parallel, and the emitting optical fiber adapters are correspondingly arranged with the focusing lens.

15. The optical module of claim 13, wherein the optical transceiver part further comprises an emission cover plate;
the lower surface of the transceiver body is provided with a first engaging surface, and the first engaging surface and the side wall of the transceiver body form a first limiting notch;
the emission cover plate comprises a first emission cover plate and a second emission cover plate, wherein a first end of the first emission cover plate is engaged with the first limiting notch, a second end of the first emission cover plate is covered on a first end of the second emission cover plate, and a second end of the second emission cover plate is engaged on the lower surface of the circuit board; one side of the first end of the second emission cover plate is provided with a second notch, and the second notch is engaged with end face of the side wall of the transceiver body and inner surface of the side wall of the transceiver body.

16. The optical module of claim 15, wherein a side of the second emission cover plate facing the circuit board is provided with a support protrusion and a first avoidance groove, the support protrusion is in contact with the lower surface of the circuit board, and a depth of the first avoidance groove is correspondingly arranged with thickness of corresponding electronic components on the circuit board.

17. The optical module of claim 15, wherein one end of the lower surface of the transceiver body facing towards the circuit board is provided with a second engaging surface, and the second engaging surface and the side wall of the transceiver body form a second limiting notch;
one side of the second emission cover plate facing towards the circuit board protrudes outwards to form a first supporting boss, and the first supporting boss is in contact with the second engaging surface; and a side of the second emission cover plate is correspondingly arranged with the side wall of the transceiver body, so that the second emission cover plate is engaged at the second limiting notch.

18. The optical module of claim 13, wherein a carrying member is arranged in the transceiver body along a length direction of the transceiver body, and the carrying member is located on the second emitting groove; the multiplexer group is arranged on the carrier member.

19. The optical module of claim 1, wherein the first notch comprises a bottom surface, a first side and a second side, wherein the first side and the second side are arranged opposite to each other, the first side is in contact with the upper surface of the circuit board, a glue groove is arranged on the first side, and the glue groove is configured for arranging glue.

20. The optical module of claim 1, wherein,
the optical receiving chip group comprises a plurality of optical receiving chips arranged in parallel, and first pads of the plurality of optical receiving chips are arranged at equal intervals;
there is a first spacing between any two adjacent optical outlets of the plurality of optical outlets of each demultiplexer, and there is a second spacing between two adjacent optical outlets of two adjacent demultiplexers, and the second spacing is greater than the first spacing;
the optical path offset piece group is configured in such a way that a spacing between any two adjacent offset optical paths is equal to the pitch first pads of two adjacent optical receiving chips of the optical receiving chip group.
